(19) United States
(12) Patent Application Publication
(10) Pub. No.: US 2022/0334273 A1
(43) Pub. Date: Oct. 20, 2022

(54) RADIATION IMAGING APPARATUS AND RADIATION IMAGING SYSTEM

(71) Applicant: CANON KABUSHIKI KAISHA, Tokyo (JP)

(72) Inventors: Hiroki Asai, Kanagawa (JP); Kanako Sato, Kanagawa (JP)

(21) Appl. No.: 17/658,298

(22) Filed: Apr. 7, 2022

(30) Foreign Application Priority Data
Apr. 16, 2021 (JP) 2021-069920
Apr. 16, 2021 (JP) 2021-069921
Mar. 22, 2022 (JP) 2022-046037

(51) Int. Cl. G01T 1/20; G01T 1/17

(52) U.S. Cl. CPC G01T 1/20184; G01T 1/17

(57) ABSTRACT

A radiation imaging apparatus comprising pixels, a driver configured to control the pixels via drive lines, a detector configured to detect radiation irradiation, and an image processor configured to generate image data based on signals read out from the pixels via column signal lines is provided. The pixels are divided into at least two pixel groups connected to drive lines different from each other. Each column signal line is shared by pixels forming two columns in the pixels. During a time until the detector detects a start of radiation irradiation, the driver causes the pixels to sequentially perform a reset operation, and after an end of radiation irradiation, the image processor generates preview image data from image signals output from the pixel group that does not include pixels that perform the reset operation when the detector detects radiation irradiation.

### BACKGROUND OF THE INVENTION

### Field of the Invention

The present invention relates to a radiation imaging apparatus and a radiation imaging system.

### Description of the Related Art

In medical image diagnosis or nondestructive inspection, a radiation imaging apparatus using a flat panel detector (FPD) made of a semiconductor material is widely used. Japanese Patent Laid-Open No. 2014-194408 describes a radiation imaging apparatus which, to obtain synchronization with a radiation generating apparatus, detects the presence/absence of radiation irradiation using the fact that when the radiation imaging apparatus is irradiated with radiation, a current (bias current) flows to a bias line configured to supply a bias potential to a pixel. Also, Japanese Patent Laid-Open No. 2014-194408 describes repeating reset scanning during detection of radiation irradiation and, after the end of radiation irradiation, generating preview image data based on signals output from pixels other than a row selected at the time of detection of radiation irradiation.

### SUMMARY OF THE INVENTION

A read circuit configured to read out signals from a number of pixels arranged in the FPD accounts for a large percentage of the member cost of the radiation imaging apparatus because an analog amplifier and an A/D converter are arranged and integrated at a high density for each column signal line to which the signals are read out from the pixels.

Some embodiments of the present invention provide a technique advantageous for obtaining an excellent preview image while suppressing the circuit scale of a read circuit in a radiation imaging apparatus.

According to some embodiments, a radiation imaging apparatus comprising: a plurality of pixels each including a conversion element configured to convert radiation into charges and arranged to form a plurality of rows and a plurality of columns; a drive circuit configured to control the plurality of pixels via a plurality of drive lines arranged to extend in a row direction; a bias source configured to supply a bias voltage to the conversion element via a bias line; a detector configured to detect presence/absence of radiation irradiation based on a current flowing to the bias line; and an image processor configured to generate image data based on signals read out from the plurality of pixels via a plurality of column signal lines arranged to extend in a column direction, wherein the plurality of pixels are divided into at least two pixel groups connected to drive lines different from each other in the plurality of drive lines, each column signal line of the plurality of column signal lines is shared by pixels forming two columns in the plurality of pixels, during a time until the detector detects a start of radiation irradiation, the drive circuit is configured to cause the plurality of pixels to sequentially perform a reset operation via the plurality of drive lines, and after an end of radiation irradiation, the image processor is configured to generate preview image data from image signals output from the pixel group that does not include, of the plurality of pixels, pixels that perform the reset operation when the detector detects radiation irradiation, is provided.

According to some other embodiments, a radiation imaging apparatus comprising: a pixel unit in which a plurality of pixels configured to convert radiation into charges are arranged to form a plurality of rows and a plurality of columns; a drive circuit configured to control the plurality of pixels via a plurality of drive lines arranged to extend in a row direction; a detector configured to detect presence/absence of radiation irradiation; and an image processor configured to generate image data based on signals read out from the plurality of pixels, wherein the plurality of pixels are divided into at least two pixel groups connected to drive lines different from each other in the plurality of drive lines, during a time until the detector detects a start of radiation irradiation, the drive circuit is configured to cause the plurality of pixels to perform a reset operation on a pixel group basis in a column direction from a side of a first row to a side of a final row in the pixel unit, and after an end of radiation irradiation, the image processor is configured to set a row in which, of the plurality of pixels, reset pixels that perform the reset operation when the detection unit detects radiation irradiation are arranged to a reset row, and is configured to generate preview image data using, of first image signals output from a pixel group including the reset pixels, image signals output from pixels of at least one row in the pixels arranged from a row next to the reset row to the final row, and of second image signals output from a pixel group that does not include the reset pixels, image signals output from pixels arranged from the first row to the reset row, is provided.

Further features of the present invention will become apparent from the following description of exemplary embodiments (with reference to the attached drawings).

### BRIEF DESCRIPTION OF THE DRAWINGS

FIG. 1 is a block diagram showing an example of the configuration of a radiation imaging system using a radiation imaging apparatus according to the embodiment;

FIG. 2 is a view showing an example of the configuration of the radiation imaging apparatus shown in FIG. 1;

FIG. 3 is a flowchart for explaining the operation of the radiation imaging system using the radiation imaging apparatus shown in FIG. 1;

FIG. 4 is a timing chart for explaining the operation of the radiation imaging apparatus shown in FIG. 1;

FIGS. 5A and 5B are timing charts for explaining the operation of the radiation imaging apparatus shown in FIG. 1;

FIG. 6 is a timing chart for explaining the operation of the radiation imaging apparatus shown in FIG. 1;

FIGS. 7A and 7B are views showing an example of the configuration of pixels that perform the reset operation of the radiation imaging apparatus shown in FIG. 1;

FIGS. 8A and 8B are views showing an example of the configuration of pixels for preview image data in the radiation imaging apparatus shown in FIG. 1;

FIGS. 9A and 9B are views showing an example of the configuration of pixels that perform the reset operation of the radiation imaging apparatus shown in FIG. 1;

FIG. 10 is a timing chart for explaining the operation of the radiation imaging apparatus shown in FIG. 1;

FIGS. 11A to 11D are views showing an example of the configuration of pixels that perform the reset operation of the radiation imaging apparatus shown in FIG. 1;

FIG. 12 is a view showing an example of the configuration of pixels for preview image data in the radiation imaging apparatus shown in FIG. 1;

FIGS. 13A to 13D are views showing an example of the configuration of pixels that perform the reset operation of the radiation imaging apparatus shown in FIG. 1; and

FIG. 14 is a flowchart showing an example of the operation between the radiation imaging apparatus and a console shown in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Radiation according to the present invention can include not only α-rays, β-rays, γ-rays, and the like, which are beams generated by particles (including photons) emitted by radioactive decay but also beams having equal or more energy, for example, X-rays, particle beams, and cosmic rays.

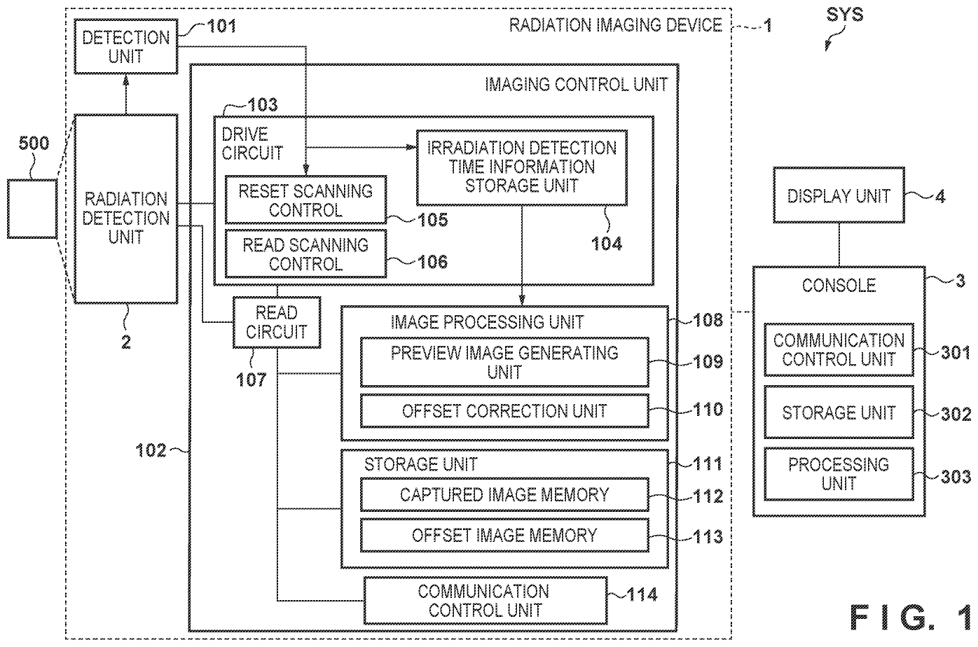

The configuration and the operation of a radiation imaging apparatus according to this embodiment will be described with reference to FIGS. 1 to 9. FIG. 1 is a block diagram showing an example of the configuration of a radiation imaging system SYS using a radiation imaging apparatus 1 according to this embodiment. The radiation imaging system SYS according to this embodiment includes the radiation imaging apparatus 1, a console 3 configured to control the radiation imaging apparatus 1, a display unit 4, and a radiation generating unit 500 configured to irradiate an object with radiation.

The radiation imaging apparatus 1 includes a radiation detection unit 2 configured to detect radiation and generate an image signal according to the incident radiation, a detection unit 101 configured to detect the start or end of radiation irradiation, and an imaging control unit 102 configured to control an imaging operation in the radiation imaging apparatus 1.

The imaging control unit 102 includes a drive circuit 103 that controls driving of the radiation detection unit 2, a read circuit 107 that controls readout of an image signal from the radiation detection unit 2, and an image processing unit 108 that generates image data based on signals read out from pixels arranged in the radiation detection unit 2. The imaging control unit 102 also includes a storage unit 111 that stores an image acquired from the radiation detection unit 2, and a communication control unit 114 that controls data communication with the console 3 to, for example, transfer an acquired image or image data generated by the image processing unit 108 to the console 3. As the communication between the radiation imaging apparatus 1 and the console 3 by the communication control unit 114, for example, wireless LAN communication can be used. However, the communication between the radiation imaging apparatus 1 and the console 3 is not limited to wireless LAN communication, and may be wireless communication by another method or wired communication using a cable.

The drive circuit 103 executes reset scanning control 105 for performing a discharge operation (reset operation) of accumulated dark charges in the radiation detection unit 2 periodically or at an arbitrary timing. In addition, the drive circuit 103 executes read scanning control 106 of performing drive control for reading out an image from the radiation detection unit 2. Also, the drive circuit 103 includes an irradiation detection time information storage unit 104 configured to store information at the time of irradiation, for example, the row number of a pixel row that performs the reset operation at the start of radiation irradiation.

The console 3 includes a communication control unit 301 that controls communication between the radiation imaging apparatus 1 and the console 3 to, for example, receive image data transferred from the radiation imaging apparatus 1. The console 3 also includes a storage unit 302 that stores image data transferred from the radiation imaging apparatus 1, and a processing unit 303 that generates, from the image data, a signal used for image display on the display unit 4. The processing unit 303 can be a processor that processes a signal output from the radiation imaging apparatus 1. For example, the processing unit 303 can perform, for image data transferred from the radiation imaging apparatus 1 to the console 3, signal processing for causing the display unit 4 to display the image data as a radiation image. In addition, for example, the processing unit 303 may perform correction processing for the image data when causing the display unit 4 to display the radiation image.

The imaging control unit 102 may read out a program stored in, for example, the storage unit 111 and perform overall control of the radiation imaging apparatus 1 based on the readout program. As the control of the radiation imaging apparatus 1, for example, apparatus control may be performed by a control signal generating circuit (control circuit) by an ASIC or the like, or overall control of the radiation imaging apparatus 1 may be implemented by both the program and the control circuit.

The radiation detection unit 2 includes a plurality of pixels each including a conversion element configured to convert radiation into charges, and arranged to form a plurality of rows and a plurality of columns. The drive circuit 103 controls the plurality of pixels via a plurality of drive lines arranged to extend in the row direction. For example, a combination of a switch element such as a TFT and a photoelectric conversion element forms one pixel, and a plurality of pixels are arranged in a two-dimensional array, thereby configuring the radiation detection unit 2. On each pixel, for example, a scintillator is formed. In this case, radiation that has entered the radiation detection unit 2 is converted, by the scintillator, into light (for example, visible light) of a wavelength convertible by the conversion element. The light converted by the scintillator enters the photoelectric conversion element of each pixel, and the photoelectric conversion element generates charges according to the incident light. In this embodiment, an indirect type conversion element that converts incident radiation into charges by the above-described scintillator and the photoelectric conversion element will be described as a configuration example. However, the conversion element is not limited to the indirect type element. For example, a so-called direct conversion type conversion element that directly converts incident radiation into charges without providing a scintillator may be used as the conversion element. The radiation detection unit 2 performs switching between ON (conductive state) and OFF (nonconductive state) of a switch element, thereby executing charge accumulation and charge readout in a pixel and acquiring a radiation image.

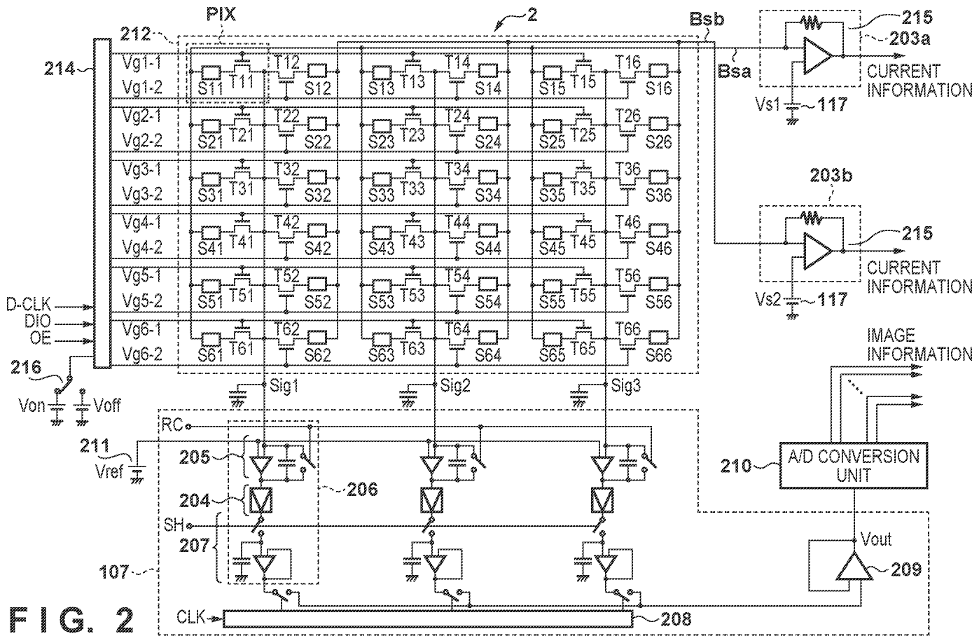

FIG. 2 is a view showing an example of the configuration of the radiation detection unit 2. In the radiation detection unit 2 shown in FIG. 2, a pixel unit 212 including pixels PIX of 6 rows×6 columns is shown for the sake of simplicity of description. However, more pixels PIX can be arranged in the actual pixel unit 212. For example, in a 17-inch pixel unit 212, the pixels PIX of about 3000 rows×about 3000 columns can be arranged.

The radiation detection unit 2 is a two-dimensional detector including the pixel unit 212 with the plurality of pixels PIX arranged in a matrix. The pixels PIX include conversion elements S (S11 to S66) configured to convert radiation into charges, and switch elements T (T11 to T66) configured to output electrical signals according to the charges generated by the conversion elements S, respectively. In this embodiment, a scintillator (wavelength conversion element) that converts irradiated radiation into light, as described above, and a MIS or PIN photodiode (photoelectric conversion element) that converts the light converted by the scintillator into charges are used as the conversion element S. Also, as described above, a direct type conversion element that directly converts radiation into charges may be used as the conversion element S. As the switch element T, a transistor including a control terminal and two main terminals can be used. In this embodiment, a thin film transistor (TFT) is used as the switch element T. One electrode of the conversion element S is electrically connected to one of the two main terminals of the switch element T, and the other electrode is electrically connected to a bias source 203 via a common bias line Bs. In the configuration shown in FIG. 2, two systems including a bias source 203a connected via a bias line Bsa, and a bias source 203b connected via a bias line Bsb are shown. If the two systems need not particularly be discriminated, the bias sources will be referred to as, for example, a bias source 203. To specify one bias source, it will be referred to as, for example, the bias source 203a. This also applies to any other constituent element including a plurality of elements. Providing two systems of the bias lines Bs and the bias sources 203 will be described later.

In the configuration shown in FIG. 2, the plurality of switch elements T arranged along the row direction, for example, the switch elements T11, T13, and T15 are connected to a drive line Vg1-1 of a plurality of drive lines Vg arranged to extend in the row direction, and the switch elements T12, T14, and T16 are connected to a drive line Vg1-2 of the plurality of drive lines Vg. The plurality of pixels PIX arranged in the pixel unit 212 of the radiation detection unit 2 are thus divided into at least two pixel groups connected to the different drive lines Vg in the plurality of drive lines Vg. In this embodiment, it can be said that each pixel PIX arranged along the row direction belongs to any one of the two pixel groups. Here, the row direction indicates a horizontal direction in FIG. 2. In addition, the column direction is a direction crossing the row direction and indicates a vertical direction in FIG. 2.

Signals generated by the pixels PIX are read out by the read circuit 107 via a plurality of column signal lines Sig arranged to extend in the column direction and transferred to the image processing unit 108 or the storage unit 111 described above. In this embodiment, as shown in FIG. 2, each column signal line Sig of the plurality of column signal lines Sig is shared by the pixels PIX of the plurality of pixels PIX, which form two columns. This makes it possible to suppress the circuit scale of the read circuit 107 to be described later as compared to a case in which the column signal line is arranged for each pixel column.

In this embodiment, as shown in FIG. 2, of the plurality of pixels PIX, the pixels PIX that are adjacent to each other in the row direction and share the same column signal line Sig of the plurality of column signal lines Sig belong to pixel groups different from each other. More specifically, the plurality of switch elements T arranged along the column direction, for example, the switch element T11 and the switch element T12 of the pixels PIX belonging to pixel groups different from each other are electrically connected to the column signal line Sig1. During the conductive state of the switch element T11 or the switch element T12, a signal according to charges generated in the conversion element S11 or the conversion element S12 is output to the read circuit 107 via the column signal line Sig1. Similarly, the switch elements T21, T31, T41, T51, and T61 and the switch elements T22, T32, T42, T52, and T62 are electrically connected to the column signal line Sig1. This also applies to the switch elements T (pixels PIX) connected to column signal lines Sig2 and Sig3. The plurality of column signal lines Sig arranged in the column direction parallelly transmit signals output from the plurality of pixels PIX to the read circuit 107.

In the read circuit 107, an amplification circuit 206 that amplifies the signals parallelly output from the pixel unit 212 is provided in correspondence with each column signal line Sig. The amplification circuit 206 includes an integrating amplifier 205 that amplifies the signals output from the pixels PIX, a variable amplifier 204 that amplifies the output of the integrating amplifier 205, and a sample and hold circuit 207 that samples and holds the electrical signal amplified by the variable amplifier 204.

The integrating amplifier 205 includes an operational amplifier that amplifies the signal read out from the pixel PIX and outputs it, an integral capacitor, and a reset switch. The integrating amplifier 205 can change the amplification factor by changing the value of the integral capacitor. The signal output from the pixel PIX is input to the inverting input terminal of the operational amplifier of the integrating amplifier 205, a reference voltage Vref from a reference power supply 211 is input to the noninverting input terminal, and the amplified signal is output from the output terminal. The integral capacitor is arranged between the inverting input terminal and the output terminal of the operational amplifier of the integrating amplifier 205. The sample and hold circuit 207 is provided in each amplification circuit 206 and configured to include a sampling switch and a sampling capacitor.

Also, the read circuit 107 includes a multiplexer 208 that outputs signals parallelly read out from the amplification circuit 206 sequentially as a series signal, and a buffer amplifier 209 that performs impedance conversion of the series signal output from the multiplexer 208 and outputs the signal. A signal Vout that is the analog electrical signal output from the buffer amplifier 209 is converted into a digital signal by an A/D converter 210 and supplied to the image processing unit 108 or the storage unit 111.

A power supply unit (not shown) transforms power from a battery or outside into a voltage according to each power supply and supplies the power to the reference power supply 211 or the bias source 203 shown in FIG. 2. The reference power supply 211 supplies the reference voltage Vref to the noninverting input terminal of the operational amplifier of the integrating amplifier 205. The bias source 203 supplies a bias voltage Vs to the conversion elements S via the bias line Bs. Also, in this embodiment, the bias source 203 outputs, to the detection unit 101, current information including a time variation of a current amount supplied to the bias line Bs. In this embodiment, a current/voltage conversion circuit 215 configured to include an operational amplifier and a resistor is used as the circuit that outputs the current information. However, the present invention is not limited to this configuration. For example, a current/voltage conversion circuit using a shunt resistor may be used as the circuit that outputs the current information. Also, the circuit that outputs the current information may output the current information as a digital value using an A/D conversion circuit that converts the output voltage of the current/voltage conversion circuit into a digital value. Furthermore, the circuit that outputs the current information may output a physical amount corresponding to the current amount supplied to the bias line Bs as the current information.

A drive circuit 214 of the radiation detection unit 2 outputs a drive signal including a conductive voltage Vcom for setting the switch element T in a conductive state and a nonconductive voltage Vss for setting the switch element T in a nonconductive state to each drive line Vg in accordance with control signals D-CLK, OE, and DIO input from the drive circuit 103 shown in FIG. 1. Accordingly, the drive circuit 214 controls the conductive state or the nonconductive state of the switch element T and drives each pixel PIX of the pixel unit 212.

The control signal D-CLK is the shift clock of a shift register that can be used as the drive circuit 214. The control signal DIO is a pulse that the drive circuit 214 transfers. The control signal OE is a signal for controlling the output terminal of the drive circuit 214. With the above signals, the drive circuit 103 sets the time needed for driving of the pixel unit 212 and the scanning direction via the drive circuit 214. Also, the drive circuit 103 gives control signals RC, SH, and CLK to the read circuit 107, thereby controlling the operation of each constituent element of the read circuit 107. Here, the control signal RC controls the operation of the reset switch of the integrating amplifier 205. The control signal SH controls the operation of the sample and hold circuit 207. The control signal CLK controls the operation of the multiplexer 208.

If the image signal converted into a digital value by the A/D converter 210 is the signal of a radiation image obtained by radiation irradiation, for example, the signal may be stored in a captured image memory 112 of the storage unit 111. If the signal is the signal of an offset image (to be sometimes simply referred to as an offset image hereinafter) acquired from only the dark charge component of each pixel PIX without radiation irradiation, the signal of the offset image may be stored in an offset image memory 113 of the storage unit 111. The signal of the radiation image and the signal of the offset image may be stored in the memories of the storage unit 111 after the image processing unit 108 performs signal processing such as correction processing. In the configuration shown in FIG. 1, the components of the captured image memory 112 and the offset image memory 113 are separately arranged in the storage unit 111. However, the present invention is not limited to this. It is only necessary to store the signal of the radiation image and the signal of the offset image in appropriate storage (memory) areas of the storage unit 111.

The image processing unit 108 can include a preview image generating unit 109 and an offset correction unit 110, as shown in FIG. 1. The preview image generating unit 109 will be described later. The offset correction unit 110 functions as a processing unit configured to perform offset correction for subtracting the component of an offset image from the signal of a radiation image. This can suppress mixing of an unnecessary dark charge component into the obtained radiation image and display a radiation image of higher quality on the display unit 4. In the configuration shown in FIG. 1, the components of the preview image generating unit 109 and the offset correction unit 110 are separately arranged in the image processing unit 108. However, the present invention is not limited to this. Any configuration can be employed if preview image generation or offset correction is done by the image processing unit 108.

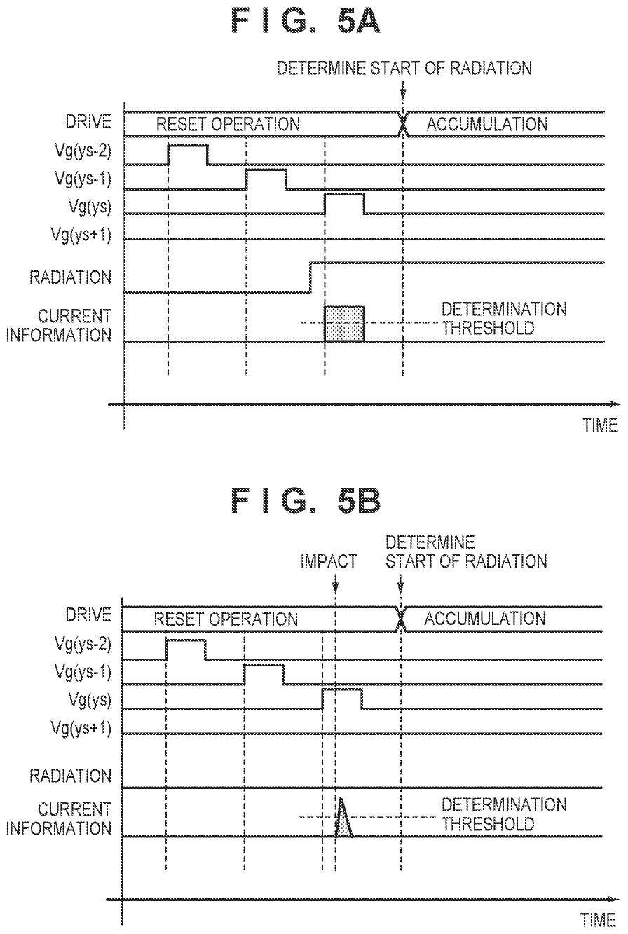

Concerning the detection unit 101 that detects the start or end of radiation irradiation, an example of drive timing at the time of detection of radiation irradiation will be described next with reference to FIG. 5A. Here, a row in which the start of radiation irradiation is determined in the radiation imaging apparatus 1 will be explained as a row Ys. FIG. 5A is an enlarged view in the vicinity of the row Ys that is the row in which the start of radiation irradiation is determined.

FIG. 5A shows current information output from the bias source 203 and used by the detection unit 101 to output radiation information including a time variation of the intensity of radiation that enters the pixel unit 212. The detection unit 101 acquires radiation information from the information of the current flowing to the bias line Bs, which is acquired from the bias source 203, and determines the start of radiation irradiation. That is, the detection unit 101 detects the start of radiation irradiation based on a signal output when the plurality of pixels PIX perform the reset operation. Referring to FIG. 5A, radiation irradiation starts during scanning between a row (Ys-1) and the row Ys, the information of the current flowing to the bias line Bs exceeds a determination threshold at the time of scanning of the row Ys, and the detection unit 101 determines that radiation irradiation starts. Based on the result of the determination, the drive circuit 103 shifts the pixels PIX to an accumulation operation for acquiring a radiation image. However, as shown in FIG. 5B, in scanning of the row Ys, an influence of external noise may be added due to an impact or a magnetic field, and the information of the current flowing to the bias line Bs may exceed the determination threshold. For this reason, in the example shown in FIG. 5B, an impact is added at the time of dummy read of the row Ys, the information of the current flowing to the bias line Bs exceeds the determination threshold, and the detection unit 101 erroneously determines that radiation irradiation starts. Based on this determination, the drive circuit 103 shifts the pixels PIX to the accumulation operation.

To detect the start of radiation irradiation, the detection unit 101 may directly use the sample value of the current signal flowing to the bias line Bs. However, to prevent a determination error as shown in FIG. 5B, processing may be executed for pieces of information of currents flowing to a plurality of bias lines Bs, and the detection unit 101 may detect radiation irradiation.

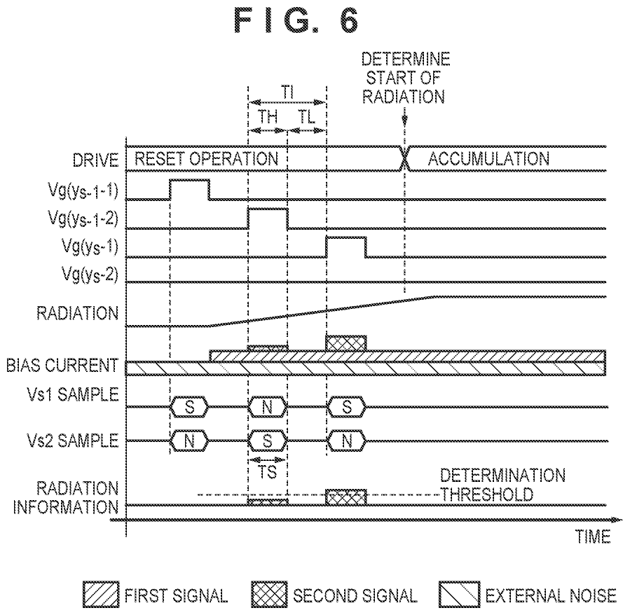

An example in which the detection unit 101 detects radiation irradiation using the pieces of information of the currents flowing to the plurality of bias lines Bs will be described with reference to FIG. 6. During radiation irradiation, a signal representing that a current proportional to the radiation irradiation amount per unit time flows to the bias line Bs is shown as a first signal in FIG. 6. This current can flow more in a case in which the switch element T of the pixel PIX is in the ON (conductive) state than in a case in which the switch element T is in the OFF (nonconductive) state, but shown as a constant current in FIG. 6 for the sake of simplicity. When the switch element T of the pixel PIX irradiated with radiation is turned on, a current proportional to the amount of charges accumulated in the conversion element S of the pixel PIX until the switch element T is turned on flows to the bias line Bs. This current is shown as a second signal in FIG. 6. When an impact or a magnetic field is applied to the radiation imaging apparatus 1, a current according to the frequency of the applied noise can flow to the bias line Bs. This current is called external noise and shown as external noise in FIG. 6. For example, a current at about 50 to 60 Hz can flow to the bias line Bs due to the influence of an electromagnetic field generated from a commercial power supply. Also, when an impact is input to the radiation imaging apparatus, a current at several Hz to several kHz can flow to the bias line Bs. Internal noise such as switching noise of the switch element T or system noise can also be considered but is omitted in FIG. 6 for the sake of simplicity.

As shown in FIG. 6, the drive period of the drive circuit 214 is represented by a time TI. That is, the radiation imaging apparatus 1 performs one reset operation (dummy read) in every time TI. Of the time TI, a time in which the drive circuit 214 supplies a high-level drive signal (a time in which the switch element T is in the conductive state) is represented by a time TH, and a time in which the drive circuit 214 supplies a low-level drive signal (a time in which the switch element T is in the nonconductive state) is represented by a time TL. Also, as shown in FIG. 6, a period in which the detection unit 101 samples the pieces of information of the currents flowing to the bias lines Bsa and Bsb from the bias sources 203a and 203b is represented by a time TS.

In this embodiment, as shown in FIG. 2, the radiation detection unit 2 includes the two bias sources 203. Hence, two pieces of information of currents flowing to the bias lines Bsa and Bsb can simultaneously be acquired in one time TS. It is therefore possible to remove external noise by calculating the difference between a sample value S of current information output from the pixel PIX whose switch element T is in the conductive state and a noise value N of current information output from the pixel PIX whose switch element T is in the nonconductive state. As a result, the detection unit 101 can accurately extract the second signal derived from a current proportional to the amount of charges accumulated in the conversion element S of the pixel PIX by radiation irradiation until the switch element T is turned on.

That is, in this embodiment, the bias sources 203a and 203b supply the bias voltage to the conversion elements S via the bias lines Bsa and Bsb that are electrically independent for each of at least two pixel groups. When detecting the start of radiation irradiation, the detection unit 101 acquires a signal value representing a current flowing to the bias line (here, the bias line Bsa) connected to the pixel group including the pixel PIX performing the reset operation in the plurality of pixels PIX and a signal value representing a current flowing to the bias line Bsb connected to the pixel group that does not include the pixel PIX performing the reset operation in the plurality of pixels PIX such that the sampling timings at least partially overlap. The start of radiation irradiation is determined based on the signal value representing the current flowing to the bias line Bsa and the signal value representing the current flowing to the bias line Bsb. Hence, the detection unit 101 can suppress detection of noise as shown in FIG. 5B as the start of radiation irradiation.

In this embodiment, two independent drive lines Vg are connected to the pixels PIX arranged along the row direction. However, one drive line Vg may be connected. In this case, one piece of current information can be obtained in one time TS, and timings of acquiring the sample value and a noise value are different, but the radiation information calculation method is the same. Alternatively, for example, the sample value and the noise value may simultaneously be acquired from two rows adjacent to each other. In this case, the drive line Vg is connected to each row of the pixels PIX, and the bias voltage Vs may be supplied from the bias sources 203 to the pixels PIX of rows adjacent to each other via the bias lines Bs that are electrically independent of each other.

In addition, when the detection unit 101 detects the start of radiation irradiation, the drive circuit 214 may simultaneously supply signals for causing a plurality of pixels PIX to perform the reset operation to at least two drive lines Vg connected to the pixels PIX belonging to the same pixel group in the plurality of pixels PIX. Accordingly, in one reset operation, a current proportional to charges accumulated in the pixels PIX corresponding to an arbitrarily set row flows to the bias line Bs. As a result, the S/N ratio of the information of the current flowing to the bias line Bs can be improved. At this time, the simultaneously driven drive lines Vg may be adjacent to each other or not. The radiation imaging apparatus 1 may be configured to change the number of drive lines Vg to be simultaneously driven in the reset operation based on, for example, a user designation. In this case, when the number of drive lines Vg to be simultaneously driven increases, switching noise of the switch elements T also increases. Hence, the gain of the detection unit 101 may be switched in accordance with the number of drive lines Vg to be simultaneously driven.

The preview image generating unit 109 will be described next. The preview image generating unit 109 of the image processing unit 108 generates preview image data to improve the usability for the user after capturing of a radiation image. The preview image is an image using signals output from some of the pixels PIX arranged in the pixel unit 212 and is quickly displayed on the display unit 4 after imaging, thereby improving the usability for the user.

At this time, the image processing unit 108 may generate preview image data by performing, for the image signal, processing including offset processing based on the signals read out from the plurality of pixels PIX without radiation irradiation. An image signal from which an unnecessary dark charge component is removed may be reduced for a preview image.

For example, after the preview image generating unit 109 of the image processing unit 108 acquires an image signal, an offset image based on signals read out from the plurality of pixels PIX without radiation irradiation may be acquired, and the offset correction unit 110 of the image processing unit 108 may perform offset correction based on the offset image. In this case, the offset image may be formed by, in signals read out from the plurality of pixels PIX without radiation irradiation, signals output from a pixel group that does not include the pixels that perform the reset operation at the time of detection of radiation irradiation by the detection unit 101 in the plurality of pixels PIX. This can shorten the time until the offset image is acquired as compared to a case in which signals are read out from all pixels PIX. The image processing unit 108 transfers the preview image data that has undergone the offset correction by the offset correction unit 110 to the console 3 under the control of the communication control unit 114. Hence, the generated preview image is displayed on the display unit 4 connected to the console 3.

Also, for example, an offset image based on signals read out from the plurality of pixels PIX without radiation irradiation may be stored in the offset image memory 113 of the storage unit 111. The image processing unit 108 may perform offset correction based on the offset image stored in the offset image memory 113. In the image processing unit 108, after the preview image generating unit 109 acquires an image signal output from the pixel unit 212, the offset correction unit 110 performs offset correction using one offset image stored in the offset image memory 113 of the storage unit 111, thereby generating preview image data. The image processing unit 108 transfers the generated preview image data to the console 3 under the control of the communication control unit 114. Accordingly, the generated preview image is displayed on the display unit 4 connected to the console 3. The time until display of the preview image can be shortened by performing offset correction using the already acquired offset image.

Here, the offset image stored in the offset image memory 113 may be an image reduced for a preview image. However, if there exist a plurality of processing patterns to be reduced for a preview image, a plurality of offset images need to be stored. For this reason, if the number of processing patterns to be reduced for a preview image is large, the memory size of the offset image memory 113 can be made small by storing an offset image according to the signals output from all pixels PIX in the offset image memory 113 and generating an offset image for preview in accordance with the processing pattern.

After that, image data that has undergone the offset correction by the offset correction unit 110 using the offset image acquired after capturing of the radiation image is transferred to the console 3 under the control of the communication control unit 114. A radiation image based on the transferred image data is displayed as a main image on the display unit 4 connected to the console 3.

The communication control unit 301 of the console 3 controls data transmission/reception to/from the radiation imaging apparatus 1, and operates, for example, software installed in a computer or the like. Accordingly, data transmission/reception to/from the imaging control unit 102 is controlled to set imaging parameters such as an imaging part and an imaging condition. Here, the processing unit 303 of the console 3 can function as a processor that performs image processing (signal processing) for converting image data received from the radiation imaging apparatus 1 into a from suitable for diagnosis. In addition, the storage unit 302 of the console 3 stores image data received form the radiation imaging apparatus 1. The display unit 4 displays a radiation image based on a signal read out from the radiation detection unit 2, an operation UI, and the like based on image data transmitted to the console 3.

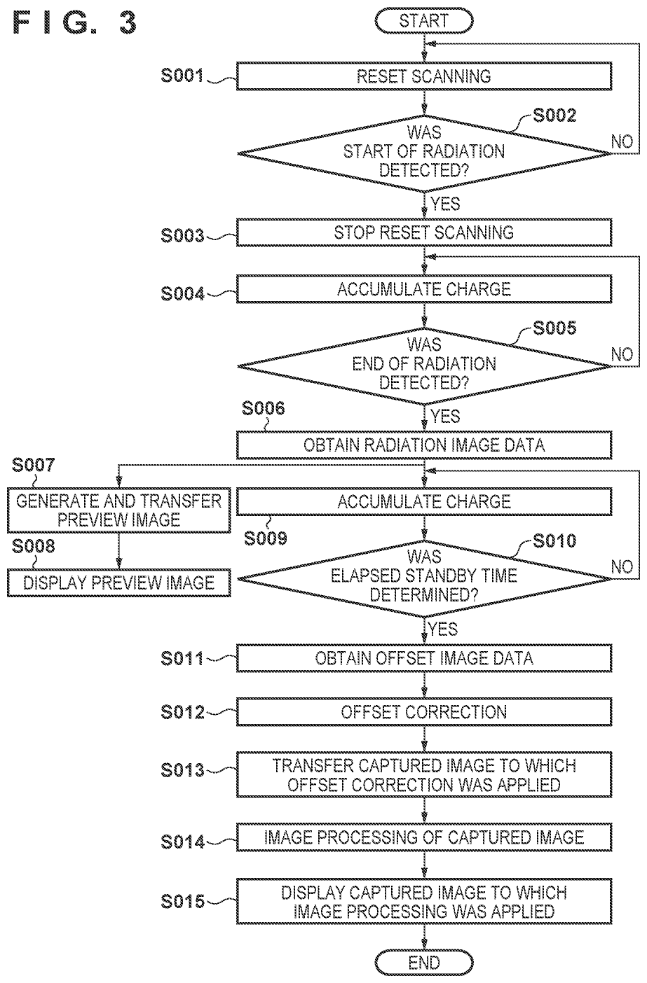

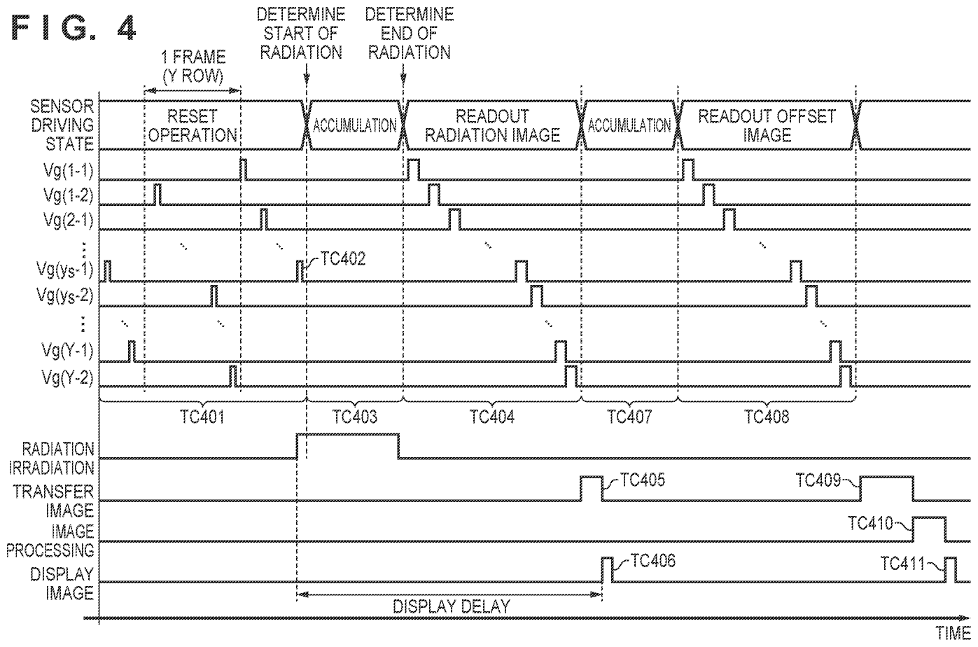

FIGS. 3 and 4 are, respectively, a flowchart and a timing chart of imaging by the radiation imaging apparatus 1 and the radiation imaging system SYS according to this embodiment. The operation of the radiation imaging apparatus 1 will be described with reference to FIGS. 3 and 4.

When the radiation imaging apparatus 1 is activated and set in an imaging standby state, as the reset scanning control 105, the drive circuit 103 periodically executes a reset operation to prevent dark charges from being accumulated in the plurality of pixels PIX constructing the radiation detection unit 2 (FIG. 4: TC401, FIG. 3: S001). The reset operation is sequentially performed from the top row (first row) to the final row (Yth row) of the pixels PIX of the pixel unit 212 and returns to the top row when reaching the final row. Next, in step S002 shown in FIG. 3, the detection unit 101 determines whether radiation irradiation from the radiation generating unit 500 has started. That is, when the detection unit 101 is detecting the presence/absence of radiation irradiation, the drive circuit 103 controls the drive circuit 214 to cause the plurality of pixels PIX to sequentially perform the reset operation via the plurality of drive lines Vg. If the detection unit 101 does not detect the start of radiation irradiation, the reset operation is repetitively executed (FIG. 4: TC401, FIG. 3: S001).

When radiation irradiation from the radiation generating unit 500 is started in response to a user operation of, for example, pressing an exposure switch, the detection unit 101 detects radiation irradiation. If the detection unit 101 detects the start of radiation irradiation, the drive circuit 103 stops the reset scanning control 105 to stop the reset operation (FIG. 4: TC402, FIG. 3: S003). Next, the drive circuit 103 shifts to the read scanning control 106 to set the switch elements T of all pixels PIX of the pixel unit 212 in the nonconductive state to obtain a state in which charges are accumulated in all pixels PIX (FIG. 4: TC403, FIG. 3: S004). When the reset operation stops, each pixel PIX is set in a state in which charges according to radiation irradiation are accumulated.

At this time, the drive circuit 103 stores the information of the pixel unit 212 at the time of stop of the reset operation as additional information in the irradiation detection time information storage unit 104. The additional information includes at least one of the information of the drive lines Vg that supply signals for causing the plurality of pixels PIX to perform the reset operation when the detection unit 101 detects radiation irradiation, the information of the pixel group to which, of the plurality of pixels PIX, the pixels PIX that perform the reset operation when the detection unit 101 detects radiation irradiation belong, a signal value when the detection unit 101 detects radiation irradiation, and the information of the arrangement of each of the pixel groups of the plurality of pixels PIX. The additional information is information concerning display of a preview image or a main image displayed on the display unit 4 after the preview image.

Next, in step S005, the detection unit 101 determines whether radiation irradiation is ended. If radiation irradiation is not ended, the operation of accumulating charges in the pixels PIX is continued (FIG. 4: TC403, FIG. 3: S004). If the detection unit 101 detects the end of radiation irradiation, the drive circuit 103 performs, in the read scanning control 106, read control for sequentially scanning the rows of the pixel unit 212, thereby acquiring image signals from the pixels PIX of the pixel unit 212 (FIG. 4: TC404, FIG. 3: S006). Here, the acquired image signals for a radiation image may be stored in the captured image memory 112.

In the image signals output from the pixels PIX and used to display a radiation image, image signals of some rows may be degraded by a detection delay from the start of actual radiation irradiation to the radiation irradiation detection by the detection unit 101. More specifically, in the pixels PIX that perform the reset operation at the time of detection of radiation irradiation, the amount of charges accumulated in accordance with radiation irradiation by executing the reset operation may be smaller than the amount of radiation that has actually entered. When displaying a preview image, to suppress the influence of degradation of the image signals, the preview image generating unit 109 of the image processing unit 108 acquires the information of the pixel unit 212 at the time of stop of the reset operation, which is stored in the irradiation detection time information storage unit 104. The preview image generating unit 109 of the image processing unit 108 thus specifies, of the image signals, signals from the pixels PIX, which are highly likely to be deficient.

The end timing of radiation irradiation may be detected by the detection unit 101. Alternatively, when the imaging control unit 102 stands by for a specific fixed time, the irradiation may be regarded to have ended, and the read operation may be started. If the end of radiation irradiation is detected by the detection unit 101, for example, a pixel row that performs the reset operation at the time of detection of the start of radiation irradiation may continue monitoring the amount of the current flowing to the bias line Bs while keeping the switch elements T in the conductive state without setting them in the nonconductive state. With this operation, the detection unit 101 can detect the end of radiation irradiation.

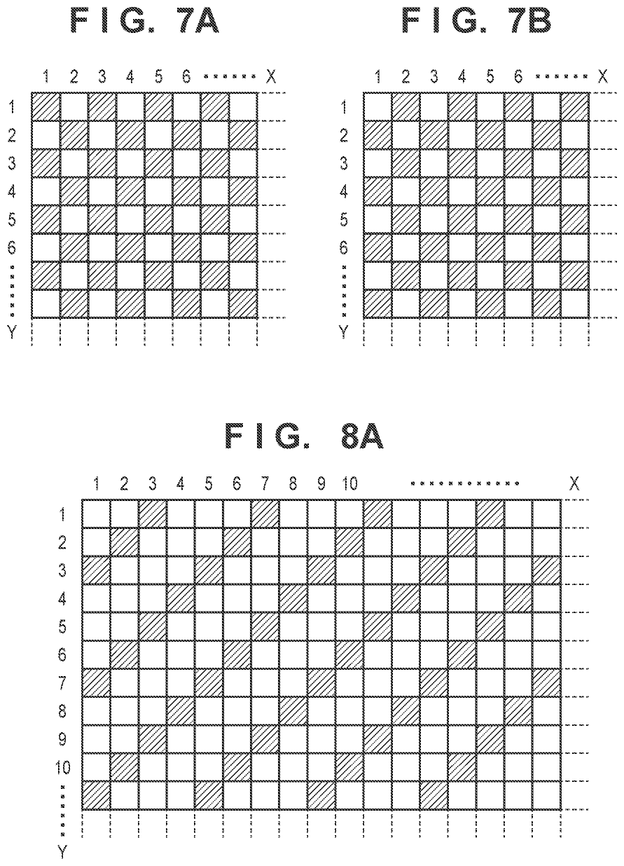

Next, the preview image generating unit 109 of the image processing unit 108 decides image signals to be used to generate preview image data. In this embodiment, two pixels PIX that are adjacent to each other in the same row, belong to different pixel groups, and are connected to different drive lines Vg share the column signal line Sig. Hence, when performing the reset operation at the drive timing as shown in FIG. 4, for example, the reset operation of the pixels PIX at coordinates (odd number, odd number) or (even number, even number), as shown in FIG. 7A, and the reset operation of the pixels PIX at coordinates (odd number, even number) or (even number, odd number), as shown in FIG. 7B, can be performed on a row basis. When the reset operation of the pixels PIX shown in FIGS. 7A and 7B is repeated on a row basis, all pixels PIX can be scanned.

At this time, a case in which the start of radiation irradiation is detected by the reset operation of the pixels PIX at the coordinates shown in FIG. 7A will be considered. In this case, in image signals output from the pixels PIX at the coordinates shown in FIG. 7B, which do not perform the reset operation at the time of radiation irradiation detection, outflow of charges by the reset operation does not occur, and therefore, the possibility that signal degradation occurs is low. For this reason, the preview image generating unit 109 of the image processing unit 108 generates preview image data from the image signals output from the pixels PIX shown in FIG. 7B (FIG. 3: S007). Next, the communication control unit 114 transfers the preview image data generated by the preview image generating unit 109 to the console 3 before main image data for diagnosis (FIG. 4: TC405, FIG. 3: S007). The preview image data transferred to the console 3 can immediately be displayed on the display unit 4 because signal degradation at the time of detection of the start of radiation irradiation is suppressed, and there is little necessity of image correction processing (FIG. 4: TC406, FIG. 3: S008).

In this way, after the end of radiation irradiation, the image processing unit 108 generates the preview image data from the image signals output from the pixel group that does not include the pixels PIX performing the reset operation in the plurality of pixels PIX when the detection unit 101 detects radiation irradiation. This makes it possible to generate the preview image data at a high speed without performing correction processing derived from the reset operation at the start of radiation irradiation. That is, it is possible to implement the radiation imaging apparatus 1 and the radiation imaging system SYS, which can display a preview image on the display unit 4 in a short time after capturing of a radiation image and ensure high usability.

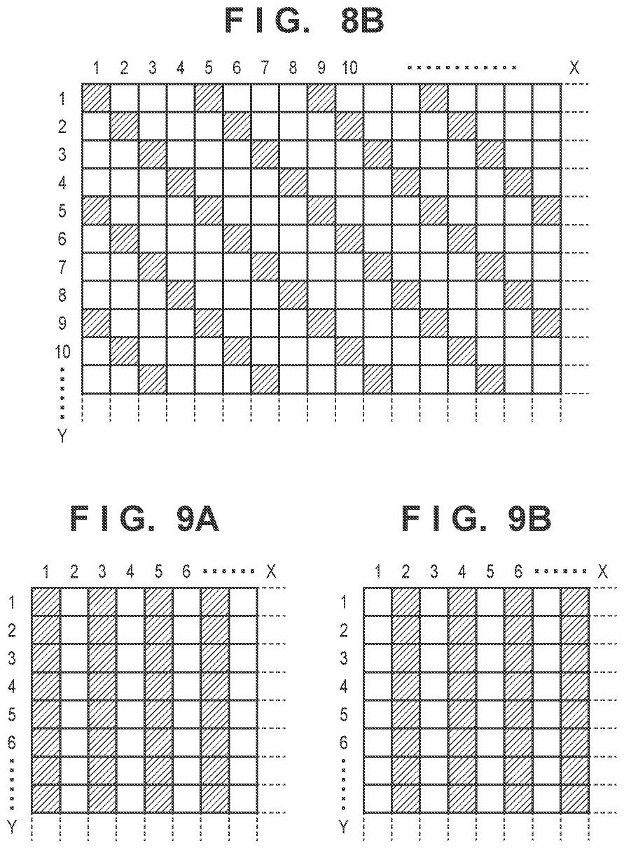

Here, when generating preview image data by the preview image generating unit 109 of the image processing unit 108, the preview image data may be generated by further performing thinning and reduction of data of pixels other than the selected pixels in the partial reset operation at the time of irradiation detection. When generating thinned and reduced image data, the preview image generating unit 109 of the image processing unit 108, for example, thins out the pixels PIX whose signals are used, as shown in FIG. 8A, thereby generating a reduced preview image as a reduced captured image and transferring it to the console 3. In FIG. 8A, for example, the hatched pixels PIX are used to generate (sample) reduced preview image data, and the solid-white pixels PIX are targets of thinning.

As shown in FIG. 8A, image signals for preview image data are sampled from the physically continuing pixels PIX. This can reduce, by thinning, the influence of specific frequency noise, like periodic signals (grid stripes) corresponding to the arrangement of a grid configured to remove scattered radiation on an object. The method of sampling image signals of reduced preview image data by the preview image generating unit 109 of the image processing unit 108 is not limited to the example shown in FIG. 8A, and another thinning method can be used. For example, for pixels used to generate reduced preview image data, the reduced preview image may be generated using interpolation processing. The reduced preview image may be generated by combining interpolation processing and the pixel values of pixels used to generate the reduced preview image. The ratio of thinning is not limited to that shown in FIG. 8A, and various ratios can be set.

On the other hand, a case in which the start of radiation irradiation is determined by the reset operation of the pixel group to which the pixels PIX selected in FIG. 7B belong will be considered. In this case, not in the pixel group to which the pixels PIX shown in FIG. 7B belongs but in the pixels PIX shown in FIG. 7A, outflow of charges generated by radiation irradiation caused, which is caused by the reset operation, does not occur, and therefore, the possibility that signal degradation does not occur is high. At this time, if the image signals of the hatched pixels PIX in FIG. 8A are used to generate reduced preview image data, the pixels PIX whose image signals degrade are included because all the hatched pixels are the pixels PIX shown in FIG. 7B. Hence, if the start of radiation irradiation is detected by the reset operation of the pixels PIX shown in FIG. 7B, the image signals output from the pixels PIX of the pixel group to which the pixels PIX shown in FIG. 7A belong are used to generate preview image data. The preview image data generated by the preview image generating unit 109 of the image processing unit 108 is transferred to the console 3 before main image data for diagnosis, and the preview image is displayed on the display unit 4. When generating thinned and reduced image data, the preview image generating unit 109, for example, thins the pixels PIX whose image signals are used to generate the preview image data, as shown in FIG. 8B, thereby generating reduced preview image data of a smaller data amount and transferring it to the console 3. The preview image data transferred to the console 3 can immediately be displayed on the display unit 4 because signal degradation caused by the reset operation at the time of detection of the start of radiation irradiation is suppressed, and there is little necessity of image correction processing. At this time, the preview image data transferred to the console 3 may include, as additional information, information necessary for preview image display, such as information representing that the data is preview image data, the information of the drive lines Vg to which signals for causing the plurality of pixels PIX to perform the reset operation when the detection unit 101 detects radiation irradiation, the information of the pixel group to which the pixels PIX that perform the reset operation when the detection unit 101 detects radiation irradiation belong, the information of the arrangement of each of the pixel groups of the plurality of pixels PIX, and the information representing the presence/absence of thinning of the pixels PIX that output image signals to be used to generate preview image data in the plurality of pixels PIX. The additional information can include identification information used to identify whether image signals transferred for the preview image are, for example, image signals output from the pixels PIX shown in FIG. 8A or image signals output from the pixels PIX shown in FIG. 8B. That is, the identification information can be the information of the pixels PIX that output the image signals used to generate the preview image data in the plurality of pixels PIX. Details of the identification information will be described later.

After completion of the read operation of the image signals to be used for a radiation image (FIG. 3: S006), as the read scanning control 106, the drive circuit 103 controls the drive circuit 214 to set the switch elements T of all pixels PIX in the nonconductive state again and set the conversion elements S in the charge accumulation state (FIG. 4: TC407, FIG. 3: S009). This processing may be executed in parallel to the above-described preview image data generation, preview image data transfer processing (FIG. 4: TC405, FIG. 3: S007), and preview image data display processing (FIG. 4: TC406, FIG. 3: S008). When parallel processing is performed, the time from preview image data generation and preview image display to generation of main image data for diagnosis and main image display can be shortened.

Next, in step S010 of FIG. 3, in the read scanning control 106, the drive circuit 103 determines whether a standby time equal to the accumulation time (FIG. 4: TC403, FIG. 3: S004) during radiation irradiation has elapsed. If the standby time has not elapsed, the operation of accumulating charges is continued in the conversion elements S (FIG. 4: TC407, FIG. 3: S009). Hence, accumulation of dark charges is continued. Upon determining that the time equal to the accumulation time during radiation irradiation has elapsed, in the read scanning control 106, the drive circuit 103 executes an operation of reading out offset image signals from the pixels PIX, thereby acquiring an offset image of only the dark charge component (FIG. 4: TC408, FIG. 3: S011). Next, the offset correction unit 110 of the image processing unit 108 performs offset correction using the acquired offset image for the signals output from all pixels PIX in the image signals of the radiation image stored in the captured image memory 112 (FIG. 3: S012). The offset correction unit 110 performs offset correction for subtracting the offset image data component from the radiation image data, thereby acquiring main image data from which the dark charge component is removed. The communication control unit 114 transfers the main image data that has undergone the offset correction by the offset correction unit 110 to the console 3 (TC409, S013).

Unlike the preview image, in the main image, degradation may occur in the signals output from pixel rows close to the pixels PIX that perform the reset operation at the time of detection of the start of radiation irradiation. For this reason, the signals of the main image data need to be corrected. The drive circuit 103 reads out, from the irradiation detection time information storage unit 104, the additional information of the pixel unit 212 at the time of stop of the reset operation and adds the additional information to the main image data generated by the offset correction unit 110 of the image processing unit 108. The communication control unit 114 transfers the additional information to the console 3. The processing unit 303 of the console 3 may specify the pixels PIX whose signals are assumed to be degraded based on, of the additional information, the information of the drive lines Vg that supply signals for causing the plurality of pixels PIX to perform the reset operation when the detection unit 101 detects radiation irradiation, or the information of the pixel group to which, of the plurality of pixels PIX, the pixels PIX that perform the reset operation when the detection unit 101 detects radiation irradiation belong. In addition, for example, the processing unit 303 of the console 3 may specify the pixels PIX whose signals are assumed to be degraded, the pixels PIX on the periphery, and the information of the output values of the pixels based on a signal value when the detection unit 101 detects radiation irradiation and the information of the arrangement of each of the pixel groups of the plurality of pixels PIX. Using these pieces of specified information, the processing unit 303 executes signal processing such as correction of the signal values of the received main image data or correction for interpolating lost signal values and executes image processing suitable for various kinds of diagnoses (FIG. 4: TC410, FIG. 3: S014). The display unit 4 displays an image based on the main image data that has undergone the image processing by the processing unit 303 (FIG. 4: TC411, FIG. 3: S015).

The timing of transferring the additional information read out from the irradiation detection time information storage unit 104 to the console 3 may be before or after the main image data. Alternatively, the additional information may be added to the main image data and transferred. When additional information concerning the pixels that perform the reset operation when the detection unit 101 detects radiation irradiation is added to the main image data, the additional information can be transferred at any timing. In this embodiment, correction processing of the main image data based on the additional information is executed by the processing unit 303 of the console 3. However, the present invention is not limited to this. For example, the image processing unit 108 of the radiation imaging apparatus 1 may perform correction processing of the main image data based on the additional information.

In this case, the additional information need not be transferred to the console 3, and the image processing unit 108 performs correction processing using the information.

In this embodiment, two pixels adjacent to each other, which are arranged on the same row, belong to different pixel groups, and are connected to different drive lines Vg, are connected to the common column signal line Sig. This can suppress the circuit scale of the read circuit 107. Also, preview image data is generated from image signals output from the pixel group that does not include the pixels PIX that perform the reset operation at the time of detection of radiation irradiation by the detection unit 101 in the plurality of pixels PIX. At this time, in accordance with the arrangement of the pixels PIX of the pixel group, the selection pattern of the pixels PIX to be used to generate preview image data is switched for each frame to perform the reset operation. This makes it possible to suppress the circuit scale necessary for the radiation imaging apparatus 1, suppress the necessity of correction of the signals output from the pixels PIX at the time of detection of the start of radiation irradiation, and reduce the delay until a processed preview image is displayed.

In the pixels PIX (pixel groups) shown in FIGS. 7A and 7B, of the plurality of pixels PIX, the pixels PIX that are adjacent to each other in the row direction and share the same column signal line Sig in the plurality of column signal lines Sig belong to the pixel groups different from each other. Also, of the plurality of pixels PIX, the pixels PIX that are adjacent to each other in the column direction belong to the pixel groups different from each other. In the example shown in FIGS. 7A and 7B, two pixel groups are arranged. The pixels PIX belonging to one pixel group in the plurality of pixels PIX and the pixels PIX belonging to the other pixel group in the plurality of pixels PIX are alternately arranged in the row direction, and the pixels PIX belonging to one pixel group in the plurality of pixels PIX and the pixels PIX belonging to the other pixel group in the plurality of pixels PIX are alternately arranged in the column direction.

However, the present invention is not limited to this. The pixels PIX (pixel groups) may be arranged as shown in FIGS. 9A and 9B. That is, of the plurality of pixels PIX, the pixels PIX that are adjacent to each other in the column direction may belong to the same pixel group. In the example shown in FIGS. 9A and 9B, two pixel groups are arranged. The pixels PIX belonging to one pixel group in the plurality of pixels PIX and the pixels PIX belonging to the other pixel group in the plurality of pixels PIX are alternately arranged in the row direction, and the pixels PIX belonging to one pixel group in the plurality of pixels PIX or the pixels PIX belonging to the other pixel group in the plurality of pixels PIX are continuously arranged in the column direction. In this case as well, two pixels adjacent to each other on the same row, which belong to pixel groups different from each other and are connected to different drive lines Vg, are connected to the common column signal line Sig, and the same operation as the above-described radiation imaging apparatus 1 can be implemented.

A case in which, in the reset operation (TC401, S001) shown in FIGS. 3 and 4, for example, the start of radiation irradiation is detected by reset driving of any of the pixels PIX shown in FIG. 9A will be considered. In this case, the image processing unit 108 generates preview image data using image signals output from the pixel group that does not include the pixels PIX that are perform the reset operation when the start of radiation irradiation is detected, that is, the pixels PIX shown in FIG. 9B. Similarly, a case in which the start of radiation irradiation is detected by reset driving of any of the pixels PIX shown in FIG. 9B will be considered. In this case, the image processing unit 108 generates preview image data using image signals output from the pixel group that does not include the pixels PIX that perform the reset operation when the start of radiation irradiation is detected, that is, the pixels PIX shown in FIG. 9A.

In this embodiment, the pixels PIX arranged in the pixel unit 212 are divided into two pixel groups, and the pixels PIX to acquire image signals when generating preview image data are selected. However, the present invention is not limited to this. The pixels PIX arranged in the pixel unit 212 of the radiation detection unit 2 may be divided into three or more pixel groups. For example, a case in which the pixels PIX are divided into three pixel groups, and the start of radiation irradiation is detected by the reset operation of the pixels PIX belonging to the first pixel group will be considered. In this case, the image processing unit 108 may generate preview image data using image signals output from the pixels PIX belonging to the second pixel group and the third pixel group. Also, in this case, the image processing unit 108 may generate preview image data using image signals output from the pixels PIX belonging to one of the second pixel group and the third pixel group. In the latter case, since the data amount of preview image data decreases, the delay until display of the preview image on the display unit 4 can be shorter. Grouping of the pixels PIX and the number of pixels PIX to be used for a preview image are decided appropriately in accordance with specifications required of the radiation imaging apparatus 1 or the radiation imaging system SYS.

As described above, it is possible to immediately obtain an excellent preview image while suppressing the circuit scale of the read circuit 107 in the radiation imaging apparatus 1. That is, it is possible to implement the radiation imaging apparatus 1 and the radiation imaging system SYS, which have high usability and reduce stress on the user during the operation.

Japanese Patent Laid-Open No. 2014-194408 discloses dividing a plurality of pixels into a plurality of groups, and after the end of reset scanning of one group, starting reset scanning of the next group. If the pixel group that performs reset scanning changes during the time from the start of actual radiation irradiation to detection of radiation irradiation, this may exert an influence on the quality of a preview image. An operation of the radiation imaging apparatus 1 for suppressing the influence will be described below.

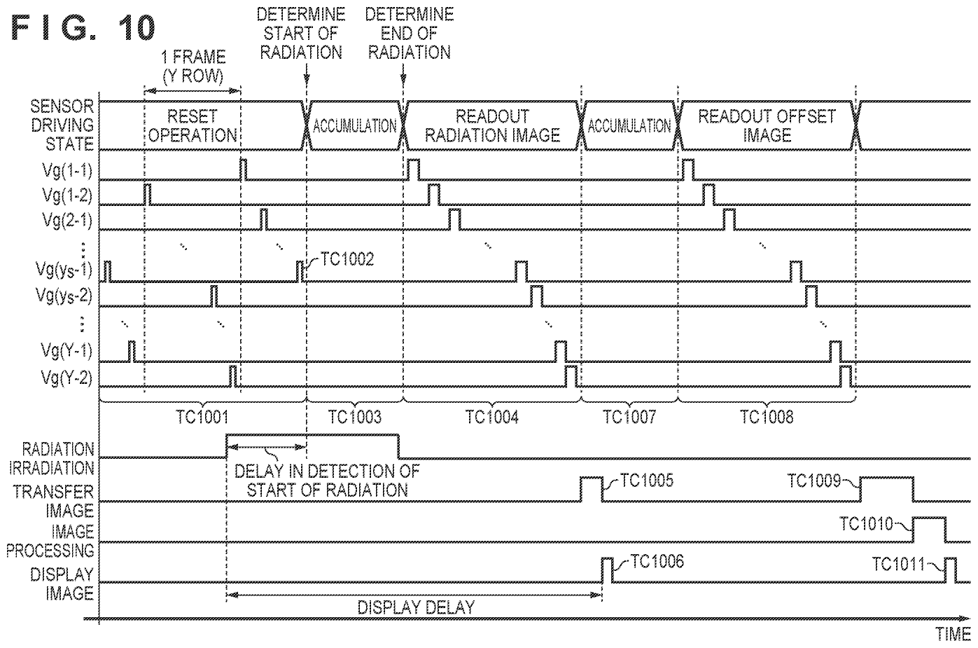

FIGS. 3 and 10 are, respectively, a flowchart and a timing chart of imaging by the radiation imaging apparatus 1 and the radiation imaging system SYS according to this embodiment. The operation of the radiation imaging apparatus 1 will be described with reference to FIGS. 3 and 10. The configurations of the radiation imaging apparatus 1 and the radiation imaging system SYS can be the same as those described above, and a description thereof will be omitted here.

When the radiation imaging apparatus 1 is activated and set in an imaging standby state, as the reset scanning control 105, the drive circuit 103 periodically executes a reset operation to prevent dark charges from being accumulated in the plurality of pixels PIX constructing the radiation detection unit 2 (FIG. 10: TC1001, FIG. 3: S001). The reset operation is sequentially performed on a pixel group basis from the side of the top row (first row) to the side of the final row (Yth row) of the pixels PIX of the pixel unit 212. When reaching the final row of one pixel group, the reset operation is started from the top row of the next pixel group. Next, in step S002 shown in FIG. 3, the detection unit 101 determines whether radiation irradiation from the radiation generating unit 500 has started. That is, when the detection unit 101 is detecting the presence/absence of radiation irradiation, the drive circuit 103 controls the drive circuit 214 to cause the plurality of pixels PIX to sequentially perform the reset operation on a pixel group basis via the plurality of drive lines Vg. If the detection unit 101 does not detect the start of radiation irradiation, the reset operation is repetitively executed (FIG. 10: TC1001, FIG. 3: S001).

When radiation irradiation from the radiation generating unit 500 is started in response to a user operation of, for example, pressing an exposure switch, the detection unit 101 detects radiation irradiation. If the detection unit 101 detects the start of radiation irradiation, the drive circuit 103 stops the reset scanning control 105 to stop the reset operation (FIG. 10: TC1002, FIG. 3: S003). Next, the drive circuit 103 shifts to the read scanning control 106 to set the switch elements T of all pixels PIX of the pixel unit 212 in the nonconductive state to obtain a state in which charges are accumulated in all pixels PIX (FIG. 10: TC1003, FIG. 3: S004). When the reset operation stops, each pixel PIX is set in a state in which charges according to radiation irradiation are accumulated.

At this time, the drive circuit 103 stores the information of the pixel unit 212 at the time of stop of the reset operation as additional information in the irradiation detection time information storage unit 104. The additional information includes at least one of the information of the drive lines Vg that supply signals for causing the plurality of pixels PIX to perform the reset operation when the detection unit 101 detects radiation irradiation, the information of the pixel group to which, of the plurality of pixels PIX, the pixels PIX that perform the reset operation when the detection unit 101 detects radiation irradiation belong, a signal value when the detection unit 101 detects radiation irradiation, and the information of the arrangement of each of the pixel groups of the plurality of pixels PIX. The additional information is information concerning display of a main image displayed on the display unit 4 after the preview image as will be described later.

Next, in step S005 shown in FIG. 3, the detection unit 101 determines whether radiation irradiation is ended. If radiation irradiation is not ended, the operation of accumulating charges in the pixels PIX is continued (FIG. 10: TC1003, FIG. 3: S004). If the detection unit 101 detects the end of radiation irradiation, the drive circuit 103 performs, in the read scanning control 106, read control for sequentially scanning the rows of the pixel unit 212, thereby acquiring image signals from the pixels PIX of the pixel unit 212 (FIG. 10: TC1004, FIG. 3: S006). Here, the acquired image signals for a radiation image may be stored in the captured image memory 112.

The end timing of radiation irradiation may be detected by the detection unit 101. Alternatively, when the imaging control unit 102 stands by for a specific fixed time, the irradiation may be regarded to have ended, and the read operation may be started. If the end of radiation irradiation is detected by the detection unit 101, for example, a pixel row that performs the reset operation at the time of detection of the start of radiation irradiation may continue monitoring the amount of the current flowing to the bias line Bs while keeping the switch elements T in the conductive state without setting them in the nonconductive state. With this operation, the detection unit 101 can detect the end of radiation irradiation.

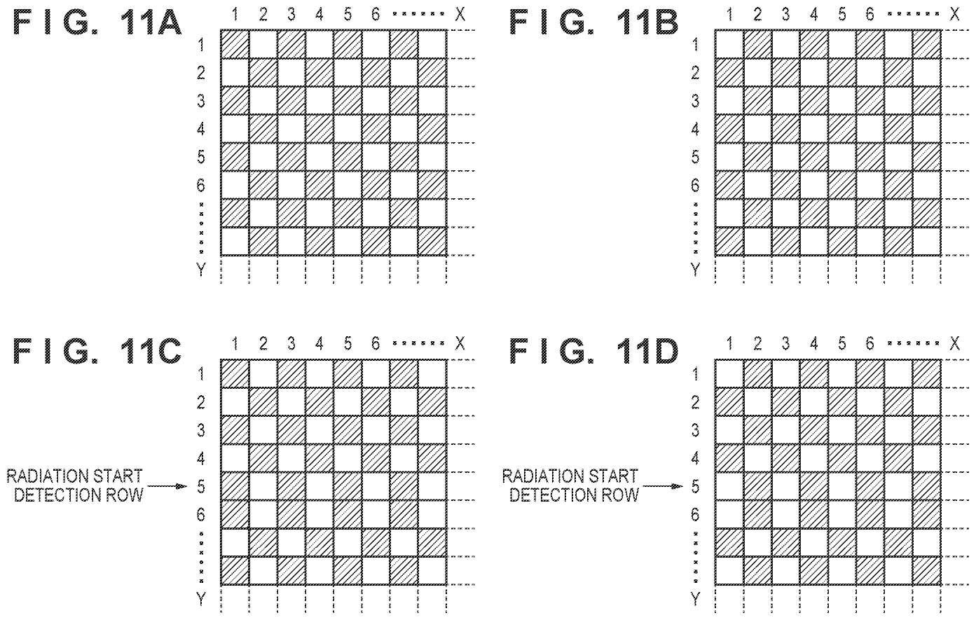

Next, the preview image generating unit 109 of the image processing unit 108 decides image signals to be used to generate preview image data. In this embodiment, two pixels PIX that are adjacent to each other in the same row, belong to different pixel groups, and are connected to different drive lines Vg share the column signal line Sig. Hence, when performing the reset operation at the drive timing as shown in FIG. 10, for example, the reset operation of a pixel group to which the pixels PIX at coordinates (odd-numbered row, odd-numbered column) or (even-numbered row, even-numbered column) as shown in FIG. 11A belong and the reset operation of a pixel group to which the pixels PIX at coordinates (odd-numbered row, even-numbered column) or (even-numbered row, odd-numbered column) as shown in FIG. 11B belong can alternately be performed. When the reset operation of the pixels PIX shown in FIGS. 11A and 11B is sequentially performed on a pixel group basis, all pixels PIX can be scanned.

In the image signals output from the pixels PIX and used to display a radiation image, image signals of some rows may be degraded by a detection delay from the start of actual radiation irradiation to the radiation irradiation detection by the detection unit 101. More specifically, in the pixels PIX that perform the reset operation during the time from the start of radiation irradiation to detection of radiation irradiation by the detection unit 101, the amount of charges accumulated in accordance with radiation irradiation by executing the reset operation may be smaller than the amount of radiation that has actually entered.

A case in which the period from the start of radiation irradiation to radiation detection by the detection unit 101 continues across the reset operations of different pixel groups, as shown in FIG. 10, will be considered here. In the operation shown in Japanese Patent Laid-Open No. 2014-194408, preview image data is generated using signals output from, of the plurality of pixels PIX, the pixels PIX of the pixel group other than the pixel group including reset pixels that perform the reset operation when the detection unit 101 detects radiation irradiation. However, in the case shown in FIG. 10, the pixel group that performs the reset operation at the time of detection of radiation irradiation is the pixel group including the pixels PIX connected to a drive line Vg(Ys-1). Hence, preview image data is generated using image signals output from the pixel group including the pixels PIX connected to a drive line Vg(Y-2). However, as shown in FIG. 10, the reset operation of the pixels PIX connected to the drive line Vg(Y-2) is performed after radiation irradiation. That is, if preview image data is generated using image signals output from the pixel group including the pixels PIX connected to the drive line Vg(Y-2), the quality of the preview image displayed on the display unit 4 may degrade due to the degradation of the image signals of the pixels PIX connected to the drive line Vg(Y-2).

In this embodiment, to suppress the influence of such degradation of the image signals, the preview image generating unit 109 of the image processing unit 108 acquires the information of the pixel unit 212 at the time of stop of the reset operation, which is stored in the irradiation detection time information storage unit 104. Here, assume that when the reset operation of the pixels PIX of the fifth row shown in FIG. 11A is performed, the detection unit 101 detects the start of radiation irradiation. First, a case in which the detection unit 101 detects radiation irradiation when the reset operation of the pixel group to which the pixels PIX at coordinates (odd-numbered row, odd-numbered column) or (even-numbered row, even-numbered column) shown in FIG. 11A belong is being performed will be considered. In this case, the fifth row is set as the boundary, and from the side of the first row to the fifth row, preview image data is generated using image signals output from the pixels PIX of the pixel group to which the pixels PIX at coordinates (odd-numbered row, even-numbered column) or (even-numbered row, odd-numbered column) shown in FIG. 11B belong, in which the reset operation is performed at low possibility during the time from the start of radiation irradiation to irradiation detection. In addition, after the fifth row where the detection unit 101 detects radiation irradiation, that is, on the side of the sixth row to the final row, preview image data is generated using image signals output from the pixels PIX of the pixel group to which the pixels PIX at coordinates (odd-numbered row, odd-numbered column) or (even-numbered row, even-numbered column) shown in FIG. 11A belong, after the end of the reset operation and the shift to the accumulation operation. That is, if radiation irradiation is detected during the reset operation of the pixel group to which the pixels PIX shown in FIG. 11A belong, the preview image generating unit 109 of the image processing unit 108 generates preview image data using image signals output from the pixels PIX shown in FIG. 11D (FIG. 3: S007).

Similarly, a case in which the detection unit 101 detects radiation irradiation when the reset operation of the pixel group to which the pixels PIX at coordinates (odd-numbered row, even-numbered column) or (even-numbered row, odd-numbered column) shown in FIG. 11B belong is being performed will be considered. In this case, the fifth row is set as the boundary, and from the side of the first row to the fifth row, preview image data is generated using image signals output from the pixels PIX of the pixel group to which the pixels PIX at coordinates (odd-numbered row, odd-numbered column) or (even-numbered row, even-numbered column) shown in FIG. 11A belong, in which the reset operation is performed at low possibility during the time from the start of radiation irradiation to irradiation detection. In addition, after the fifth row where the detection unit 101 detects radiation irradiation, that is, on the side of the sixth row to the final row, preview image data is generated using image signals output from the pixels PIX of the pixel group to which the pixels PIX at coordinates (odd-numbered row, even-numbered column) or (even-numbered row, odd-numbered column) shown in FIG. 11B belong, after the end of the reset operation and the shift to the accumulation operation. That is, if radiation irradiation is detected during the reset operation of the pixel group to which the pixels PIX shown in FIG. 11B belong, the preview image generating unit 109 of the image processing unit 108 generates preview image data using image signals output from the pixels PIX shown in FIG. 11C (FIG. 3: S007).

Next, the communication control unit 114 transfers the preview image data generated by the preview image generating unit 109 to the console 3 before main image data for diagnosis (FIG. 10: TC1005, FIG. 3: S007). The preview image data transferred to the console 3 can immediately be displayed on the display unit 4 because degradation of the image signals derived from the reset operation during the time from the start of radiation irradiation to irradiation detection is suppressed, and there is little necessity of image correction processing (FIG. 10: TC1006, FIG. 3: S008).

As described above, after the end of radiation irradiation, the preview image generating unit 109 of the image processing unit 108 sets a row in which, of the plurality of pixels PIX, the reset pixels (for example, the pixels PIX of the fifth row in FIG. 11A, and the same example will be shown hereinafter) that perform the reset operation when the detection unit 101 detects radiation irradiation are arranged to the reset row (fifth row). As described above, the preview image generating unit 109 of the image processing unit 108 can acquire the information of the reset row as the information of the pixel unit 212 at the time of stop of the reset operation, which is stored in the irradiation detection time information storage unit 104. Next, the preview image generating unit 109 of the image processing unit 108 generates preview image data using, of first image signals output from the pixel group including the reset pixels (the pixel group to which the pixels PIX shown in FIG. 11A belong), image signals output from the pixels PIX of at least one row in the pixels PIX arranged from the row next to the reset row to the final row, and of second image signals output from the pixel group that does not include the reset pixels (the pixel group to which the pixels PIX shown in FIG. 11B belong), image signals output from the pixels PIX arranged from the first row to the reset row. This makes it possible to generate the preview image data at a high speed without performing correction processing derived from the reset operation during the time from the start of radiation irradiation to radiation detection. That is, it is possible to implement the radiation imaging apparatus 1 and the radiation imaging system SYS, which can display a preview image on the display unit 4 in a short time after capturing of a radiation image and ensure high usability.

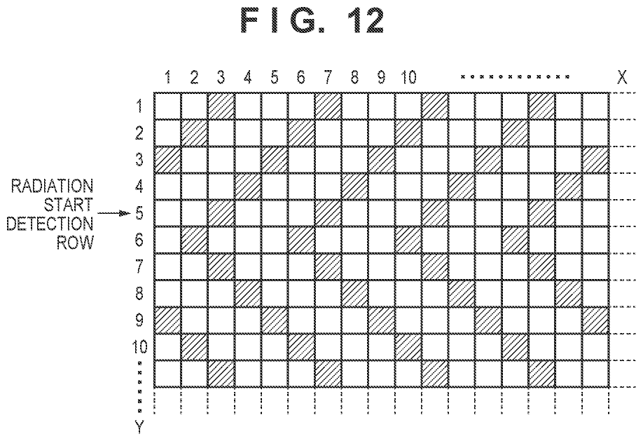

Here, when generating preview image data by the preview image generating unit 109 of the image processing unit 108, the preview image data may be generated by further performing thinning and reduction of image signals of the pixels PIX selected in the above-described way. When generating thinned and reduced image data, the preview image generating unit 109 of the image processing unit 108, for example, thins out the pixels PIX whose signals are used to display a preview image, as shown in FIG. 12, thereby generating a reduced preview image as a reduced captured image and transferring it to the console 3. In FIG. 12, for example, the hatched pixels PIX are used to generate (sample) reduced preview image data, and the solid-white pixels PIX are targets of thinning.

The method of sampling image signals of reduced preview image data by the preview image generating unit 109 of the image processing unit 108 is not limited to the example shown in FIG. 12, and another thinning method can be used. For example, for pixels used to generate reduced preview image data, the reduced preview image may be generated using interpolation processing. The reduced preview image may be generated by combining interpolation processing and the pixel values of pixels used to generate the reduced preview image. The ratio of thinning is not limited to that shown in FIG. 12, and various ratios can be set.

Also, in the above description, of the second image signals output from the pixel group that does not include the reset pixels, the image signals output from the pixels PIX arranged from the first row to the reset row are used to generate preview image data. However, of the second image signals output from the pixel group that does not include the reset pixels, some of image signals output from the pixels PIX arranged on the side of the final row with respect to the reset row may be used to generate preview image data. In the pixels PIX belonging to the pixel group that does not include the reset pixels, the pixels PIX arranged close to the reset row perform the reset operation at low possibility during the time from the start of actual radiation irradiation to irradiation detection. For this reason, for example, of the second image signals output from the pixel group that does not include the reset pixels, image signals output from the pixels PIX arranged from the first row to the fifth row, the 10th row, or, for example, the 20th row on the side of the final row with respect to the reset row may be used to generate preview image data. Alternatively, for example, of the second image signals output from the pixel group that does not include the reset pixels, image signals output from the pixels PIX arranged from the first row to a row advanced by 1%, 2%, 5%, or, for example, 10% of the rows arranged in the pixel unit 212 on the side of the final row with respect to the reset row may be used to generate preview image data. In these cases, to generate preview image data, the preview image generating unit 109 of the image processing unit 108 may use, of the first image signals output from the pixel group including the reset pixels, image signals output from the pixels PIX arranged from the row next to the row on which the pixels PIX used to generate preview image data are arranged to the final row in the pixel group that does not include the reset pixels.

In this way, the radiation imaging apparatus 1 includes a plurality of selection patterns of the pixels PIX to be used to generate the preview image such that the pixels PIX that perform the reset operation at high possibility during the time from the start of actual radiation irradiation to irradiation detection are not used to generate the preview image. Based on the scanning line selected at the time of detection of the start of radiation irradiation, the preview image generating unit 109 of the image processing unit 108 switches the selection pattern of the pixels PIX to be used to generate preview image data. Hence, the radiation imaging apparatus 1 and the radiation imaging system SYS can display a preview image with high image quality on the display unit 4 with a short display delay. Also, as described above, the preview image data may include additional information.

After completion of the read operation of the image signals to be used for a radiation image (FIG. 3: S006), as the read scanning control 106, the drive circuit 103 controls the drive circuit 214 to set the switch elements T of all pixels PIX in the nonconductive state again and set the conversion elements S in the charge accumulation state (FIG. 10: TC1007, FIG. 3: S009). This processing may be executed in parallel to the above-described preview image data generation, preview image data transfer processing (FIG. 10: TC1005, FIG. 3: S007), and preview image data display processing (FIG. 10: TC1006, FIG. 3: S008). When parallel processing is performed, the time from preview image data generation and preview image display to generation of main image data for diagnosis and main image display can be shortened.

Next, in step S010 of FIG. 3, in the read scanning control 106, the drive circuit 103 determines whether a standby time equal to the accumulation time (FIG. 10: TC1003, FIG. 3: S004) during radiation irradiation has elapsed. If the standby time has not elapsed, the operation of accumulating charges is continued in the conversion elements S (FIG. 10: TC1007, FIG. 3: S009). Hence, accumulation of dark charges is continued. Upon determining that the time equal to the accumulation time during radiation irradiation has elapsed, in the read scanning control 106, the drive circuit 103 executes an operation of reading out offset image signals from the pixels PIX, thereby acquiring an offset image of only the dark charge component (FIG. 10: TC1008, FIG. 3: S011). Next, the offset correction unit 110 of the image processing unit 108 performs offset correction using the acquired offset image for the signals output from all pixels PIX in the image signals of the radiation image stored in the captured image memory 112 (FIG. 3: S012). The offset correction unit 110 performs offset correction for subtracting the offset image data component from the radiation image data, thereby acquiring main image data from which the dark charge component is removed. The communication control unit 114 transfers the main image data that has undergone the offset correction by the offset correction unit 110 to the console 3 (FIG. 10: TC1009, FIG. 3: S013).

Unlike the preview image, in the main image, degradation may occur in the signals output from pixel rows close to the pixels PIX that perform the reset operation at the time of detection of the start of radiation irradiation. For this reason, the signals of the main image data need to be corrected. The drive circuit 103 reads out, from the irradiation detection time information storage unit 104, the additional information of the pixel unit 212 at the time of stop of the reset operation and adds the additional information to the main image data generated by the offset correction unit 110 of the image processing unit 108. The communication control unit 114 transfers the additional information to the console 3. The processing unit 303 of the console 3 may specify the pixels PIX whose signals are assumed to be degraded based on, of the additional information, the information of the drive lines Vg that supply signals for causing the plurality of pixels PIX to perform the reset operation when the detection unit 101 detects radiation irradiation, or the information of the pixel group to which, of the plurality of pixels PIX, the pixels PIX that perform the reset operation when the detection unit 101 detects radiation irradiation belong. In addition, for example, the processing unit 303 of the console 3 may specify the pixels PIX whose signals are assumed to be degraded, the pixels PIX on the periphery, and the information of the output values of the pixels based on a signal value when the detection unit 101 detects radiation irradiation and the information of the arrangement of each of the pixel groups of the plurality of pixels PIX. Using these pieces of specified information, the processing unit 303 executes signal processing such as correction of the signal values of the received main image data or correction for interpolating lost signal values and executes image processing suitable for various kinds of diagnoses (FIG. 10: TC1010, FIG. 3: S014). The display unit 4 displays an image based on the main image data that has undergone the image processing by the processing unit 303 (FIG. 10: TC1011, FIG. 3: S015).

The timing of transferring the additional information read out from the irradiation detection time information storage unit 104 to the console 3 may be before or after the main image data. Alternatively, the additional information may be added to the main image data and transferred. When additional information concerning the pixels that perform the reset operation when the detection unit 101 detects radiation irradiation is added to the main image data, the additional information can be transferred at any timing.

In this embodiment, correction processing of the main image data based on the additional information is executed by the processing unit 303 of the console 3. However, the present invention is not limited to this. For example, the image processing unit 108 of the radiation imaging apparatus 1 may perform correction processing of the main image data based on the additional information. In this case, the additional information need not be transferred to the console 3, and the image processing unit 108 performs correction processing using the information.

The radiation imaging apparatus 1 according to this embodiment uses the information of the pixels PIX (pixel row) that perform the reset operation at the time of detection of the start of radiation irradiation. Hence, even if the period from the start of radiation irradiation to irradiation detection by the detection unit 101 continues across the reset operations of different pixel groups, it is possible to display the preview image without performing processing of correcting image degradation caused by the reset operation. This makes it possible to implement the radiation imaging apparatus 1 and the radiation imaging system SYS, which can reduce the display delay until display of a preview image and ensure high usability for the user. In addition, as shown in FIG. 2, the radiation imaging apparatus 1 according to this embodiment causes two pixel columns to share the column signal line Sig, thereby suppressing the circuit scale of the read circuit 107 and reducing the apparatus cost.

In the pixels PIX (pixel groups) shown in FIGS. 11A and 11B, of the plurality of pixels PIX, the pixels PIX that are adjacent to each other in the row direction and share the same column signal line Sig in the plurality of column signal lines Sig belong to the pixel groups different from each other. Also, of the plurality of pixels PIX, the pixels PIX that are adjacent to each other in the column direction belong to the pixel groups different from each other. In the example shown in FIGS. 11A and 11B, two pixel groups are arranged. The pixels PIX belonging to one pixel group in the plurality of pixels PIX and the pixels PIX belonging to the other pixel group in the plurality of pixels PIX are alternately arranged in the row direction, and the pixels PIX belonging to one pixel group in the plurality of pixels PIX and the pixels PIX belonging to the other pixel group in the plurality of pixels PIX are alternately arranged in the column direction.

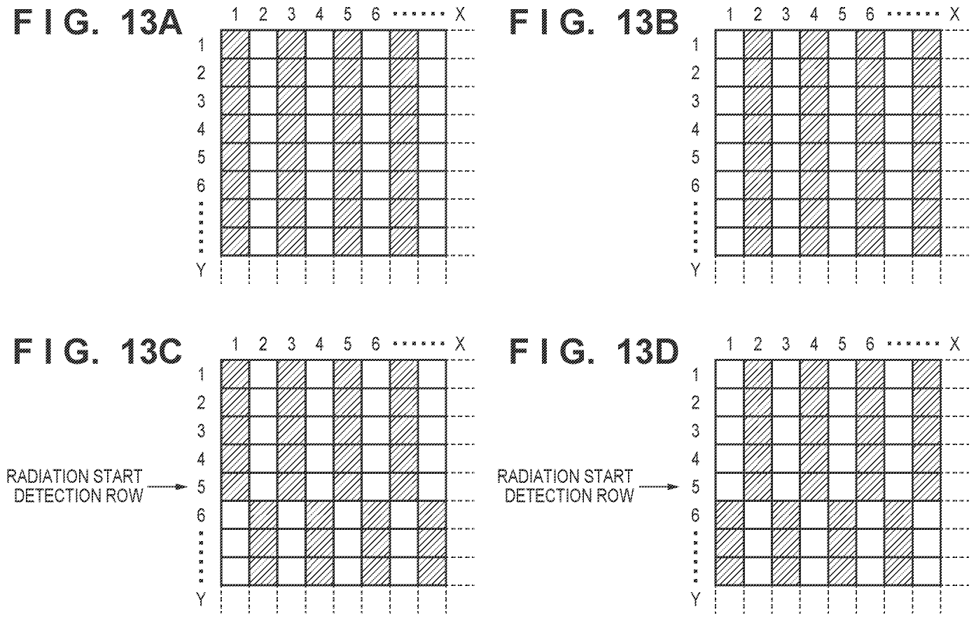

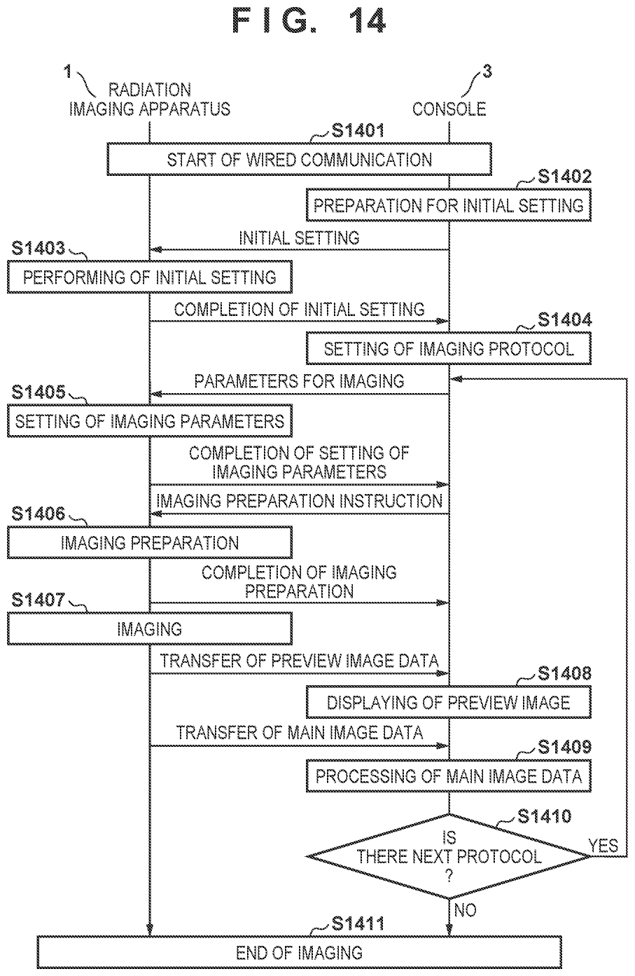

However, the present invention is not limited to this. The pixels PIX (pixel groups) may be arranged as shown in FIGS. 13A and 13B. That is, of the plurality of pixels PIX, the pixels PIX that are adjacent to each other in the column direction may belong to the same pixel group. In the example shown in FIGS. 13A and 13B, two pixel groups are arranged. The pixels PIX belonging to one pixel group in the plurality of pixels PIX and the pixels PIX belonging to the other pixel group in the plurality of pixels PIX are alternately arranged in the row direction, and the pixels PIX belonging to one pixel group in the plurality of pixels PIX or the pixels PIX belonging to the other pixel group in the plurality of pixels PIX are continuously arranged in the column direction. In this case as well, two pixels adjacent to each other on the same row, which belong to pixel groups different from each other and are connected to different drive lines Vg, are connected to the common column signal line Sig, and the same operation as the above-described radiation imaging apparatus 1 can be implemented.

A case in which in the reset operation (TC1001, S001) shown in FIGS. 3 and 10, for example, the detection unit 101 detects radiation irradiation during the reset operation of the pixel group to which the pixels PIX at the coordinates of odd-numbered columns as shown in FIG. 13A belong will be considered. In this case, the fifth row where radiation irradiation is detected in the reset operation is set as the boundary, and from the side of the first row to the fifth row, preview image data is generated using image signals output from the pixels PIX of the pixel group to which the pixels PIX at the coordinates of even-numbered columns shown in FIG. 13B belong. In addition, after the fifth row where the detection unit 101 detects radiation irradiation, that is, on the side of the sixth row to the final row, preview image data is generated using image signals output from the pixels PIX of the pixel group to which the pixels PIX at the coordinates of odd-numbered columns shown in FIG. 13A belong. That is, if radiation irradiation is detected during the reset operation of the pixel group to which the pixels PIX shown in FIG. 13A belong, the preview image generating unit 109 of the image processing unit 108 generates preview image data using image signals output from the pixels PIX shown in FIG. 13D (FIG. 3: S007).

Similarly, a case in which the detection unit 101 detects radiation irradiation during the reset operation of the pixel group to which the pixels PIX at the coordinates of even-numbered columns as shown in FIG. 13B belong will be considered. In this case, the fifth row where radiation irradiation is detected in the reset operation is set as the boundary, and from the side of the first row to the fifth row, preview image data is generated using image signals output from the pixels PIX of the pixel group to which the pixels PIX at the coordinates of odd-numbered columns shown in FIG. 13A belong. In addition, after the fifth row where the detection unit 101 detects radiation irradiation, that is, on the side of the sixth row to the final row, preview image data is generated using image signals output from the pixels PIX of the pixel group to which the pixels PIX at the coordinates of even-numbered columns shown in FIG. 13B belong. That is, if radiation irradiation is detected during the reset operation of the pixel group to which the pixels PIX shown in FIG. 13B belong, the preview image generating unit 109 of the image processing unit 108 generates preview image data using image signals output from the pixels PIX shown in FIG. 13C (FIG. 3: S007).

In the example shown in FIGS. 13A to 13D, a case in which the pixels PIX of odd-numbered columns and those of even-numbered columns belong to pixel groups different from each other has been described. However, the present invention is not limited to this. For example, the pixels PIX of odd-numbered rows and those of even-numbered rows may belong to pixel groups different from each other. In this case, for example, a case in which the detection unit 101 detects radiation irradiation during the reset operation of the pixel group to which the pixels PIX at the coordinates of odd-numbered rows belong will be considered. In this case, the row (for example, the fifth row) where radiation irradiation is detected in the reset operation is set as the boundary, and from the side of the first row to the fifth row, preview image data is generated using image signals output from the pixels PIX of the pixel group to which the pixels PIX at the coordinates of even-numbered rows belong (for example, the pixels PIX arranged on the second and fourth rows). In addition, after the fifth row where the detection unit 101 detects radiation irradiation, that is, on the side of the sixth row to the final row, preview image data is generated using image signals output from the pixels PIX of the pixel group to which the pixels PIX at the coordinates of odd-numbered rows belong (for example, the pixels PIX arranged on the seventh, ninth, . . . rows). This makes it possible to display a preview image with high image quality on the display unit 4 while suppressing the display delay.

In this embodiment, the pixels PIX arranged in the pixel unit 212 are divided into two pixel groups, and the pixels PIX to acquire image signals when generating preview image data are selected. However, the present invention is not limited to this. The pixels PIX arranged in the pixel unit 212 of the radiation detection unit 2 may be divided into three or more pixel groups. For example, a case in which the pixels PIX are divided into three pixel groups, and the start of radiation irradiation is detected by the reset operation of the pixels PIX belonging to the first pixel group will be considered. In this case, from the side of the first row to the reset row, the preview image generating unit 109 of the image processing unit 108 generates preview image data using image signals output from the pixels PIX belonging to the second pixel group and the third pixel group. At this time, preview image data may be generated using image signals output from the pixels PIX belonging to any one of the second pixel group and the third pixel group. When the number of image signals used for preview image data decreases, the data amount is suppressed and the delay until display of a preview image on the display unit 4 may be shorter. Also, from the row next to the reset row to the final row, the preview image generating unit 109 of the image processing unit 108 generates preview image data using image signals output from the pixels PIX belonging to the first pixel group. Also, in this case, the pixels PIX belonging to the first pixel group, the pixels PIX belonging to the second pixel group, and the pixels PIX belonging to the third pixel group may sequentially be arranged on one row. Also, for example, the pixels PIX belonging to the first pixel group, the pixels PIX belonging to the second pixel group, and the pixels PIX belonging to the third pixel group may sequentially be arranged on a row basis in the column direction. Grouping of the pixels PIX and the number of pixels PIX to be used for a preview image are appropriately be decided in accordance with specifications required of the radiation imaging apparatus 1 or the radiation imaging system SYS.

As described above, in the radiation imaging apparatus 1, it is possible to suppress degradation of image signals caused by the reset operation during the time from the start of radiation irradiation to irradiation detection and immediately obtain an excellent preview image. That is, it is possible to implement the radiation imaging apparatus 1 and the radiation imaging system SYS, which have high usability and reduce stress on the user during the operation.

In the above-described embodiment, a case in which the image processing unit 108 of the radiation imaging apparatus 1 decides, based on the structure of the radiation detection unit 2 or the characteristics of the drive control method, the pixels PIX whose image signals are to be used to display a preview image has been described. On the other hand, when designing the radiation imaging system SYS, the radiation imaging apparatus 1 and the console 3 are sometimes designed separately. If the radiation imaging apparatus 1 and the console 3 are designed in parallel, or the radiation imaging apparatus 1 is designed first, the console 3 is designed in consideration of the data amount of image signals, the data format, and the transfer method used to display a preview image on the radiation imaging apparatus 1 combined at the time of design of the console 3. However, if the console 3 is designed first, the data amount, the data format, and the transfer method of preview image data used to display a preview image on the radiation imaging apparatus 1 may be inappropriate for the processing of the processing unit 303 of the console 3, or the console 3 may be unable to cope with the data.

For example, if the data amount of preview image data transmitted from the radiation imaging apparatus 1 is different from the data amount assumed in the communication control unit 301 or the storage unit 302, it may be impossible to correctly receive the transferred preview image data. Also, if the signal data of preview image data are not transferred in an assumed order, the processing unit 303 may be unable to rearrange the transfer data, and it may be impossible to correctly display the preview image on the display unit 4. In addition, when the processing unit 303 performs correction processing of preview image data, it may be impossible to correctly correct the preview image data.

If images should be captured in a short cycle to capture a moving image or the like, or a lot of people should be captured in a short time in a medical examination or the like, quickly displaying a preview image may be more important than image quality. On the other hand, depending on an imaging part, image quality may be given higher priority than the display time even in a preview image. Hence, for example, before capturing a radiation image, the console 3 may transmit instruction information for instructing a preview image data generating method to the radiation imaging apparatus 1 in accordance with the imaging part or imaging technique. Here, a case in which the console 3 transmits instruction information to the radiation imaging apparatus 1, and the radiation imaging apparatus 1 decides the pixels PIX that output image signals to be used to generate preview image data in accordance with the instruction information will be described. The configurations of the radiation imaging apparatus 1 and the radiation imaging system SYS are the same as described above, and a description thereof will be omitted here.

FIG. 14 is a flowchart showing an operation example in which the console 3 transmits instruction information for instructing a preview image data generating method to the radiation imaging apparatus 1, and the radiation imaging apparatus 1 decides the pixels PIX that output image signals to be used to generate preview image data in accordance with the instruction information. For example, the processing unit 303 of the console 3 can function as a processor configured to not only perform image processing (signal processing) for changing image data received from the radiation imaging apparatus 1 into a form suitable for diagnosis but also control the operation of the radiation imaging apparatus 1, as will be described below. The flowchart of FIG. 14 will be described below.

First, communication is started between the radiation imaging apparatus 1 and the console 3 (step S1401). For example, if an auto-negotiation setting is done between the radiation imaging apparatus 1 and the console 3, the communication speed is decided by a sequence such as FLP.

Next, the console 3 transmits an initial setting command to the radiation imaging apparatus 1 as preparation for initial setting of the radiation imaging apparatus 1 (step S1402). For example, the console 3 transmits a command for setting time or acquiring the temperature information and the battery charge state of the radiation imaging apparatus 1. The radiation imaging apparatus 1 performs initial setting in accordance with the initial setting command from the console 3 (step S1403). When the initial setting is completed, the radiation imaging apparatus 1 returns parameters of the temperature information and the battery charge state of the radiation imaging apparatus 1 to the console 3 and notifies the console 3 of the completion of initial setting.

When the initial setting of the radiation imaging apparatus 1 is completed, setting of an imaging protocol is done by the user using the console 3 (step S1404). When the imaging protocol is set, an imaging part, an imaging technique, and the like are set. Hence, various kinds of parameters in the radiation imaging apparatus 1 for imaging are determined. The parameters for imaging include an imaging mode, the presence/absence of various kinds of image processing, the number of images to be captured, and an imaging ID. Also, the above-described instruction information used to decide the pixels PIX that output image signals to be used to generate preview image data is also included in the parameters for imaging. The instruction information can include the information of the number and the information of the positions of pixels PIX that output image signals to be used to generate preview image data. For example, in accordance with the instruction information, the radiation imaging apparatus 1 decides to use image signals output from the pixels PIX shown in FIG. 8A and the pixels PIX shown in FIG. 8B, which are included in the above-described different pixel groups, to generate preview image data. For example, the console 3 can transfer one of a plurality of types of instruction information to the radiation imaging apparatus 1 in accordance with the imaging part and the imaging technique. For this reason, the storage unit 111 of the radiation imaging apparatus 1 may store the information of the pixels PIX that output image signals to be used to generate preview image data in the plurality of pixels PIX in accordance with each of the plurality of types of instruction information.

The console 3 transmits the determined imaging parameters to the radiation imaging apparatus 1. A plurality of imaging settings may be done in one imaging protocol setting. Also, in this embodiment, after completion of the initial setting of the radiation imaging apparatus 1, the user sets the imaging protocol using the console 3. However, the user may set the imaging protocol using the console 3 during initial setting of the radiation imaging apparatus 1.

In accordance with the imaging parameters transmitted from the console 3, the radiation imaging apparatus 1 performs setting of imaging parameters in the radiation imaging apparatus 1 (step S1405). When the imaging parameter setting is completed, the radiation imaging apparatus 1 notifies the console 3 that the imaging parameter setting is completed.

Upon receiving the imaging parameter setting completion from the radiation imaging apparatus 1, the console 3 transmits an imaging preparation instruction command to the radiation imaging apparatus 1 (step S1405). Upon receiving the imaging preparation instruction command, the radiation imaging apparatus 1 makes imaging preparation by, for example, activating the radiation detection unit 2, the drive circuit 103, and the read circuit 107, and if the preparation is completed, notifies the console 3 of the completion of imaging preparation.

If imaging is performed by the radiation imaging apparatus 1 (step S1407), the radiation imaging apparatus 1 transfers preview image data to the console 3. Additional information that is the information of the pixel unit 212 when the above-described reset operation is stopped may be added to the transferred preview image data. Also, the additional information may include information representing that the data is preview image data. In accordance with the information of the pixel unit 212 when the reset operation is stopped, the additional information may also include identification information representing that, for example, the preview image data is generated by image signals output from the pixels PIX shown in FIG. 8A.

The console 3 receives the preview image data transferred from the radiation imaging apparatus 1, rearranges the preview image data in a predetermined order in accordance with the designated instruction information and the identification information, and causes the display unit 4 to display a preview image (step S1408). When transferring the preview image data, the console 3 may notify the radiation imaging apparatus 1 of completion of reception for each predetermined transfer unit.

Next, the console 3 receives main image data from the radiation imaging apparatus 1. For the main image data as well, the pixels PIX that output image signals to be used to generate the main image data may be decided using the above-described instruction information. In this case, the console 3 rearranges the main image data in accordance with the instruction information and displays the main image data as needed, and also performs appropriate image processing and stores the main image data (step S1409). In this case, image processing may be performed using additional information added to the main image data, as described above. When transferring the main image data, the console 3 may notify the radiation imaging apparatus 1 of completion of reception for each predetermined transfer unit, as in the transfer of the preview image data.

If a next imaging protocol setting exists (YES in step S1410), the console 3 transmits the next imaging parameter to the radiation imaging apparatus 1, and the operation advances to step S1405. On the other hand, if a next imaging protocol setting does not exist (NO in step S1410), imaging is ended (step S1411).

Transmitting instruction information for instructing the pixels PIX that output image signals to be used to generate preview image data from the console 3 to the radiation imaging apparatus 1 when transmitting imaging parameters from the console 3 to the radiation imaging apparatus 1 has been described above. However, the present invention is not limited to this. For example, the radiation imaging apparatus 1 and the console 3 may have a negotiation function such that the console 3 transmits the information of a plurality of preview image data receivable as instruction information to the radiation imaging apparatus 1, and the radiation imaging apparatus 1 selects preview image data the radiation imaging apparatus 1 can cope with. Also, for example, in addition to captured images and offset images, the user information of the radiation imaging apparatus 1 may be stored in the storage unit 111 at the time of factory shipment or the like, and a preview image data generating method suitable for the user may be transferred as instruction information from the console 3 to the radiation imaging apparatus 1.

As described above, it is possible to immediately obtain an excellent preview image while suppressing the circuit scale of the read circuit 107 in the radiation imaging apparatus 1. That is, it is possible to implement the radiation imaging apparatus 1 and the radiation imaging system SYS, which have high usability and reduce stress on the user during the operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2021-069920 and 2021-069921, filed Apr. 16, 2021, and Japanese Patent Application No 2022-046037, filed Mar. 22, 2022 which are hereby incorporated by reference herein in their entirety.

What is claimed is:

1. A radiation imaging apparatus comprising: a plurality of pixels each including a conversion element configured to convert radiation into charges and arranged to form a plurality of rows and a plurality of columns; a drive circuit configured to control the plurality of pixels via a plurality of drive lines arranged to extend in a row direction; a bias source configured to supply a bias voltage to the conversion element via a bias line; a detector configured to detect presence/absence of radiation irradiation based on a current flowing to the bias line; and an image processor configured to generate image data based on signals read out from the plurality of pixels via a plurality of column signal lines arranged to extend in a column direction,
wherein the plurality of pixels are divided into at least two pixel groups connected to drive lines different from each other in the plurality of drive lines,
each column signal line of the plurality of column signal lines is shared by pixels forming two columns in the plurality of pixels,
during a time until the detector detects a start of radiation irradiation, the drive circuit is configured to cause the plurality of pixels to sequentially perform a reset operation via the plurality of drive lines, and
after an end of radiation irradiation, the image processor is configured to generate preview image data from image signals output from the pixel group that does not include, of the plurality of pixels, pixels that perform the reset operation when the detector detects radiation irradiation.

2. The apparatus according to claim 1, wherein
the at least two pixel groups include a first pixel group and a second pixel group,
pixels belonging to the first pixel group in the plurality of pixels and pixels belonging to the second pixel group in the plurality of pixels are alternately arranged in the row direction, and
the pixels belonging to the first pixel group in the plurality of pixels and the pixels belonging to the second pixel group in the plurality of pixels are alternately arranged in the column direction.

3. The apparatus according to claim 1, wherein the image processor is configured to perform, for the image signals, processing including offset correction based on signals read out from the plurality of pixels without radiation irradiation, and is configured to generate the preview image data.

4. The apparatus according to claim 3, further comprising a storage unit configured to store an offset image based on the signals read out from the plurality of pixels without radiation irradiation,
wherein the image processor is configured to perform offset correction based on the offset image.

5. The apparatus according to claim 1, wherein
after the end of radiation irradiation, the image processor is configured to generate main image data from the image signals output from the plurality of pixels,
additional information concerning the pixels that perform the reset operation when the detector detects radiation irradiation is added to the main image data, and
the additional information includes at least one of information of drive lines that supply signals for causing the plurality of pixels to perform the reset operation when the detector detects radiation irradiation, information of the pixel group to which, of the plurality of pixels, the pixels that perform the reset operation when the detector detects radiation irradiation belong, a signal value when the detector detects radiation irradiation, and information of an arrangement of each of the at least two pixel groups of the plurality of pixels.

6. The apparatus according to claim 1, wherein
additional information concerning the pixels that perform the reset operation when the detector detects radiation irradiation is added to the preview image data, and
the additional information includes at least one of information of drive lines that supply signals for causing the plurality of pixels to perform the reset operation when the detector detects radiation irradiation, information of the pixel group to which, of the plurality of pixels, the pixels that perform the reset operation when the detector detects radiation irradiation belong, information of an arrangement of each of the at least two pixel groups of the plurality of pixels, information representing presence/absence of thinning of pixels that output image signals to be used to generate the preview image data in the plurality of pixels, and information of the pixels that output the image signals used to generate the preview image data in the plurality of pixels.

7. A radiation imaging system comprising:
the radiation imaging apparatus according to claim 1; and
a processor configured to process a signal output from the radiation imaging apparatus.

8. The system according to claim 7, wherein
the processor is configured to transmit instruction information for instructing a generating method of preview image data to the radiation imaging apparatus, and
the radiation imaging apparatus is configured to decide pixels that output image signals to be used to generate the preview image data in the plurality of pixels in accordance with the instruction information.

9. The system according to claim 8, wherein the radiation imaging apparatus comprises a storage unit configured to store information of the pixels that output the image signals to be used to generate the preview image data in the plurality of pixels in accordance with each of a plurality of types of instruction information.

10. A radiation imaging apparatus comprising: a pixel unit in which a plurality of pixels configured to convert radiation into charges are arranged to form a plurality of rows and a plurality of columns; a drive circuit configured to control the plurality of pixels via a plurality of drive lines arranged to extend in a row direction; a detector configured to detect presence/absence of radiation irradiation; and an image processor configured to generate image data based on signals read out from the plurality of pixels,
wherein the plurality of pixels are divided into at least two pixel groups connected to drive lines different from each other in the plurality of drive lines,
during a time until the detector detects a start of radiation irradiation, the drive circuit is configured to cause the plurality of pixels to perform a reset operation on a pixel group basis in a column direction from a side of a first row to a side of a final row in the pixel unit, and
after an end of radiation irradiation, the image processor is configured to set a row in which, of the plurality of pixels, reset pixels that perform the reset operation when the detection unit detects radiation irradiation are arranged to a reset row, and is configured to generate preview image data using, of first image signals output from a pixel group including the reset pixels, image signals output from pixels of at least one row in the pixels arranged from a row next to the reset row to the final row, and of second image signals output from a pixel group that does not include the reset pixels, image signals output from pixels arranged from the first row to the reset row.

11. The apparatus according to claim 10, wherein
the at least two pixel groups include a first pixel group and a second pixel group,
pixels belonging to the first pixel group in the plurality of pixels and pixels belonging to the second pixel group in the plurality of pixels are alternately arranged in the row direction, and
the pixels belonging to the first pixel group in the plurality of pixels and the pixels belonging to the second pixel group in the plurality of pixels are alternately arranged in the column direction.

12. The apparatus according to claim 10, wherein
the at least two pixel groups include a first pixel group and a second pixel group,
pixels belonging to the first pixel group in the plurality of pixels and pixels belonging to the second pixel group in the plurality of pixels are alternately arranged in the column direction, and
the pixels belonging to the first pixel group in the plurality of pixels or the pixels belonging to the second pixel group in the plurality of pixels are continuously arranged in the row direction.

13. The apparatus according to claim 10, wherein when generating the preview image data, the image processor is configured to perform processing including offset correction based on signals read out from the plurality of pixels without radiation irradiation.

14. The apparatus according to claim 13, further comprising a storage unit configured to store an offset image based on the signals read out from the plurality of pixels without radiation irradiation,
wherein the image processor is configured to perform offset correction based on the offset image.

15. The apparatus according to claim 10, wherein
after the end of radiation irradiation, the image processor is configured to generate main image data from the first image signals and the second image signals,
additional information concerning the pixels that perform the reset operation when the detector detects radiation irradiation is added to the main image data, and
the additional information includes at least one of information of drive lines that supply signals for causing the plurality of pixels to perform the reset operation when the detector detects radiation irradiation, information of the pixel group to which, of the plurality of pixels, the pixels that perform the reset operation when the detector detects radiation irradiation belong, a signal value when the detector detects radiation irradiation, and information of an arrangement of each of the at least two pixel groups of the plurality of pixels.

16. The apparatus according to claim 10, wherein
additional information concerning the pixels that perform the reset operation when the detector detects radiation irradiation is added to the preview image data, and
the additional information includes at least one of information of drive lines that supply signals for causing the plurality of pixels to perform the reset operation when the detector detects radiation irradiation, information of the pixel group to which, of the plurality of pixels, the pixels that perform the reset operation when the detector detects radiation irradiation belong, information of an arrangement of each of the at least two pixel groups of the plurality of pixels, information representing presence/absence of thinning of pixels that output image signals to be used to generate the preview image data in the plurality of pixels, and information of the pixels that output the image signals used to generate the preview image data in the plurality of pixels.

17. A radiation imaging system comprising:
the radiation imaging apparatus according to claim 10; and
a processor configured to process a signal output from the radiation imaging apparatus.

18. The system according to claim 17, wherein
the processor is configured to transmit instruction information for instructing a generating method of preview image data to the radiation imaging apparatus, and
the radiation imaging apparatus is configured to decide pixels that output image signals to be used to generate the preview image data in the plurality of pixels in accordance with the instruction information.

19. The system according to claim 18, wherein the radiation imaging apparatus comprises a storage unit configured to store information of the pixels that output the image signals to be used to generate the preview image data in the plurality of pixels in accordance with each of a plurality of types of instruction information.
